(19) United States
(12) Patent Application Publication
(10) Pub. No.: US 2010/0095357 A1
(43) Pub. Date: Apr. 15, 2010

(54) Identity theft protection and notification system

(76) Inventors: John A. Willis, Ajax (CA); David W. Foster, Gormley (CA); Igor D. Divjak, Hamilton (CA)

Correspondence Address: BLAKE, CASSELS & GRAYDON LLP, BOX 25, COMMERCE COURT WEST, 199 BAY STREET, SUITE 2800, TORONTO, ON, M5L 1A9, CA

(21) Appl. No.: 12/457,118

(22) Filed: Jun. 1, 2009

Related U.S. Application Data
(63) Continuation of application No. PCT/CA07/02128, filed on Nov. 28, 2007.

(51) Int. Cl. G06F 7/04

(52) U.S. Cl. 726/6

(57) ABSTRACT

An information monitoring and alert system is provided which registers subscribers and verifiers with a central alert system. The alert system provides an interface for the verifiers to submit queries relating to identification information. Information in this query is compared to the stored data submitted by the subscriber during registration and if a match occurs the subscriber is notified that the identification has been used for a certain purpose. The alert system only stores an encrypted value of the identification with only contact information which is preferably anonymous. Any other information is deleted after registration. The subscriber upon being alerted of the use of the identification is instructed to authorize or reject the transaction pertaining to the query.

### CROSS-REFERENCE TO RELATED APPLICATIONS

This application is a continuation of PCT Application No. PCT/CA2007/002128 filed on Nov. 28, 2007, which claims priority from U.S. patent application Ser. No. 11/565,954 filed on Dec. 1, 2006, which is a continuation-in-part of U.S. patent application Ser. No. 11/208,642 filed Aug. 23, 2005, which is a continuation of PCT Application No. PCT/CA2005/001265 filed Aug. 19, 2005 and which claims priority from U.S. Provisional Patent Application Nos. 60/602,883 filed Aug. 20, 2004, 60/617,652 filed Oct. 13, 2004, and 60/626,475 filed Nov. 10, 2004, the contents of each above-referenced application being incorporated herein by reference.

### FIELD OF THE INVENTION

The present invention relates to a secure monitoring system and methods for the notification of identity usage.

### BACKGROUND OF THE INVENTION

Personal information and identification are generally regarded as important and worthy of at least a minimum attempt for security. People need identification for driving, obtaining medical care and applying for jobs. Identification is also required by credit card companies and banks to authorize the use of their services and also by government officials for border security and airline travel security.

Credit agencies monitor the activity of people through their identification and the use of various services such as a credit card for day-to-day purchases. This activity is evaluated and people are given a credit rating which is essentially a “report card” for their ability to pay back loans and other credit purchases they may require. Therefore the use of sensitive identification information greatly affects a person's ability to mortgage property or establish credit for making large purchases.

If a person's identification has been misplaced or stolen, it could be used by an unauthorized person in various fraudulent ways. This activity could lead to negative results applied against the person's credit rating and/or other undesired outcomes. The advent of electronic commerce (E-commerce) has presented further challenges in protecting identity information since identification numbers (i.e. phone numbers, social security numbers, credit card numbers etc.) may be sent over public networks and information may be stored in an electronic database which is connected to such a public network.

The Internet enabled World Wide Web provides wide access to information flowing across its supporting infrastructure allowing a person's identity to be essentially “stolen” since any unauthorized use of their personal information can be accomplished quickly and in many different locations which may or may not be significantly remote to the person's place of residence. By the time the person realizes that unauthorized activity has occurred, the damage has often already been done and it is up to the person to rectify any incorrect or fraudulent activity.

Credit report services such as Equifax attempt to deal with identification theft by providing an automated credit watch service, Equifax Credit Watch™. This service monitors subscribing users' credit reports and provides alerts to the customers when activity occurs relating to their credit reports. The alerts are presented to the customer either within 24 hours or 7 days depending on the level of service paid for. A delay of even 24 hours is sufficient to allow a person's identification to be used in many ways and many times. Therefore, although monitoring is done, it is not nearly as responsive as necessary to track E-commerce activities. Furthermore, credit report monitoring mainly relates to financial information and does not encompass unauthorized use of other forms of identification such as a passport or driver's license.

There exist various systems which monitor transaction activity and credit report activity, namely those taught in U.S. 2003/0195859 A1 to Lawrence, U.S. 2002/0133462 A1 to Shteyn, U.S. Pat. No. 6,064,990 to Goldsmith, U.S. 2002/0169747 to Chapman et al., and U.S. 2002/0087460 A1 to Hornung. These documents teach various methods of tracking a user's credit rating and/or transaction activities and notifying them of these changes. To identify and notify the user, these systems require the storage of sensitive information. The systems are typically connected to public networks such as the World Wide Web and, therefore, this sensitive information is also prone to security risks and theft. The information stored is available to unauthorized personnel through fraudulent activities and thus the information is not secure.

To protect the transfer and storage of sensitive information, it is well known to encrypt and decrypt the information at the endpoints of the transmission. U.S. Pat. No. 6,012,144 to Pickett teaches “slicing” and encrypting data before transmission wherein each “slice” is decrypted and re-assembled at the receiving end. However, although the transmission of the sensitive data is secure, the issue remains as to the storage of the intact information. U.S. patent application publication, No. U.S. 2003/0070101 A1 to Buscemi provides a method for encrypting information and distributing a public key to decrypt. The key is distributed first to the owner of the information and can be redistributed as they desire. Again this method requires the storage of the intact confidential information which is prone to theft and/or unauthorized access.

It is therefore an object of the present invention to obviate or mitigate at least some of the above mentioned disadvantages. More specifically, a system and method is therefore required that can provide secure monitoring and protect sensitive information both in storage and during communication.

### SUMMARY OF THE INVENTION

In one aspect, a method for updating information associated with identification information is provided. The method comprises receiving a secure version of an identification datum and an indication of an incident associated with the identification datum, the incident being related to the identification datum; comparing the secure version of the identification datum to stored identification data; and if the stored identification data comprises the identification datum, updating information specific to the datum.

In another aspect, a method of identity monitoring is provided comprising a notification system storing biometric identification information and contact information for each of at least one subscriber, the identification being stored in a secure manner; the notification system receiving a query from a verifier indicative of the use of queried biometric identification information; the notification system using the query to retrieve contact information corresponding to the queried biometric identification information if the queried biometric identification information corresponds to one of the at least one subscriber; and if retrieved, the notification system using the contact information to notify the one of the at least one subscriber of the use of the queried biometric identification information.

In yet another aspect, a notification system for identity monitoring is provided comprising a storage device for storing biometric identification information and contact information for each of at least one subscriber, the biometric identification information being stored in a secure manner; an interface adapted to enable a verifier to submit a query indicative of the use of queried biometric identification information; and a server connected to the interface and the storage device, the server capable of receiving the query from the interface and transmitting a notification message to each of the at least one subscriber over a communication channel, the server using the query to retrieve contact information corresponding to the queried biometric identification information if the queried biometric identification information corresponds to one of the at least one subscriber; and if retrieved, the server using the contact information to notify the one of the one of the at least one subscriber of the use of the queried biometric identification information.

In yet another aspect, there is provided a notification system for identity monitoring comprising: an alert system comprising a database storing encrypted versions of identification data for one or more subscribers; and at least one verification agent comprising contact information for the one or more subscribers; wherein the alert system is configured to receive queries from one or more verifiers, the queries comprising encrypted versions of identification data to be verified; compare the received encrypted versions to those stored in the database; and send a result of the comparison to one of the at least one verification agent for notifying a respective one of the subscribers.

In yet another aspect, there is provided a method for anonymously storing identification data comprising: separating the identification data into a plurality of fields comprising a first field containing an identification number and a second field containing information associated with the identification number; applying a one-way hash function to each the first field and the second field to generate a first hashed field and a second hashed field respectively; and storing the first hashed field with the second hashed field; wherein the first and second hashed fields are each compared to corresponding input hashes for verifying the identification data.

In yet another aspect, there is provided a memory for storing identification data for access by an identity verification application program being executed on a data processing system comprising one or more data structures stored in the memory, the data structures including a plurality of hashed data fields stored with each other in the memory, the plurality of hashed data fields comprising a first hashed field of a first field of the identification information containing an identification number, and a second hashed field of a second field of the identification information containing information associated with the identification number.

### BRIEF DESCRIPTION OF THE DRAWINGS

Embodiments of the invention will now be described by way of example only with reference to the appended drawings wherein:

FIG. 1 is a block-type diagram of an identity monitoring system.

FIG. 2 is a schematic diagram of an implementation of the system of FIG. 1 providing notification via Email and wirelessly through a cellular phone.

FIG. 3 is a block-type diagram of an encryption function.

FIG. 4 is a schematic representation of a database.

FIG. 5 is a schematic representation of a login page provided by a web-browser.

FIG. 6 is a schematic representation of an information entry interface for supplying the input of FIG. 3.

FIG. 7 is a flow chart showing the general steps in an identity monitoring procedure.

FIG. 8 is a flow chart showing the subscriber registration procedure of FIG. 7.

FIG. 9 is a flow chart showing the verifier registration procedure of FIG. 7.

FIG. 10 is a flow chart showing the notification procedure of FIG. 7.

FIG. 11 is a flow chart showing the encryption procedure of FIG. 10.

FIG. 12 is a flow chart showing the subscriber response procedure of FIG. 7.

FIG. 13 is a flow chart showing the unmatched category filing procedure of FIG. 12.

FIG. 14 is a block-type diagram illustrating a second embodiment of the present invention involving the transmission of information between multiple subscribers.

FIG. 15 is a flow chart showing a secure bulk message posting procedure.

FIG. 16 is a flow chart showing a bulk message inquiry procedure for non-subscribers.

FIG. 17 is a flow chart showing a bulk message inquired procedure for subscribers.

FIG. 18 is a flow chart showing an email filtering procedure.

FIG. 19 is a schematic representation of a pair of security levels.

FIG. 20 is a flow chart showing a process for linking other identification numbers to the core identification numbers of FIG. 19.

FIG. 21 is a flow chart showing a solicitation procedure using the unmatched identification numbers of FIG. 20.

FIG. 22 is a schematic representation of an embodiment of the identity monitoring system utilising notarized registration.

FIG. 23 is a flow chart showing a notarized registration procedure.

FIG. 24 is a flow chart showing the steps in an embodiment of the identity monitoring system utilising random charge registration.

FIG. 25 is a schematic representation of an embodiment of the identity monitoring system comprising a verification mailbox.

FIG. 26 is a flow chart showing a procedure for handling verification attempts using the mailbox of FIG. 25.

FIG. 27 is a block-type diagram illustrating an embodiment of the identity monitoring system for communicating information between an ID holder and an ID issuer.

FIG. 28 is a schematic representation of a web-based application program interface (API) for communicating between an ID holder and an ID issuer.

FIG. 29 is a flow chart showing a procedure for reporting to an ID issuer, an incident associated with identification information for an ID holder.

FIG. 30 is a schematic block diagram of an identity monitoring system utilizing an alert system agent.

FIG. 31 is a schematic block diagram showing further detail of the alert system node in FIG. 30.

FIG. 32 is a schematic block diagram illustrating a central anonymous identification information database connected to a plurality of verifiers and a plurality of alert system agents.

FIG. 33 is a flow diagram illustrating a notification process for the system shown in FIG. 30.

FIG. 34 is a flow diagram illustrating the notification process of FIG. 33 including a verifier-to-ID issuer communication channel.

### DETAILED DESCRIPTION OF THE INVENTION

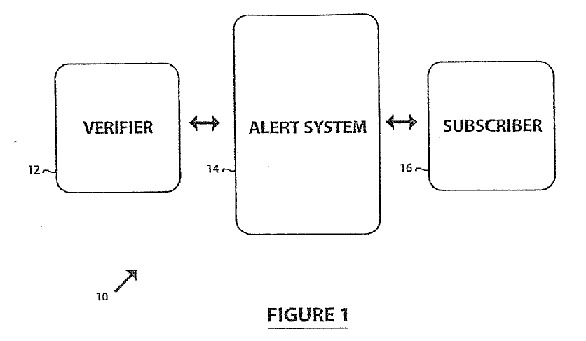

Referring therefore to FIG. 1, a secure communication system for identity monitoring 10 (“the system”) is generally comprised of a number of correspondents, for example, a verifier 12, a notification or alert system 14 and a subscriber 16. A verifier or verification entity 12 is any entity that needs to verify the identity of the subscriber 16 that they are dealing with. These entities may include but shall not be limited to credit card merchants, credit card issuers, banks, loan companies, employers, insurance companies, health care providers, landlords, leasing companies, rental companies or government agencies such as immigration, customs, law enforcement, social security and department of motor vehicles.

A subscriber 16 is a person or organization who is the authorized holder of personal or sensitive information and wishes to be notified of any use of that personal or sensitive information. The personal or sensitive information may belong to the subscriber 16 or a dependant of the subscriber 16 such as a child or a deceased relative. Subscribers 16 may include but shall not be limited to an individual (i.e. a consumer/citizen), or a business organization that uses various identification/registration numbers and credit cards.

Subscriber 16 may also comprise any entity having the right or permission to act on another's behalf, such as an executor or power of attorney. Such subscribers may for example hold power of attorney or otherwise be acting on behalf of, for example, the estate of a deceased person or for someone who is otherwise incapacitated, e.g. someone who is infirmed. Similarly, a parent or guardian of a child may also be considered someone acting on another's behalf. Therefore, although the child may be a minor, a responsible adult may subscribe to the system 10 on their behalf. A subscriber 16 may be registered or unregistered. A registered subscriber 16 is a subscriber 16 that has registered with, and been verified by the alert system 14.

An alert system 14 facilitates the monitoring process and possesses the ability to securely correlate identification data with the contact information of a subscriber 16.

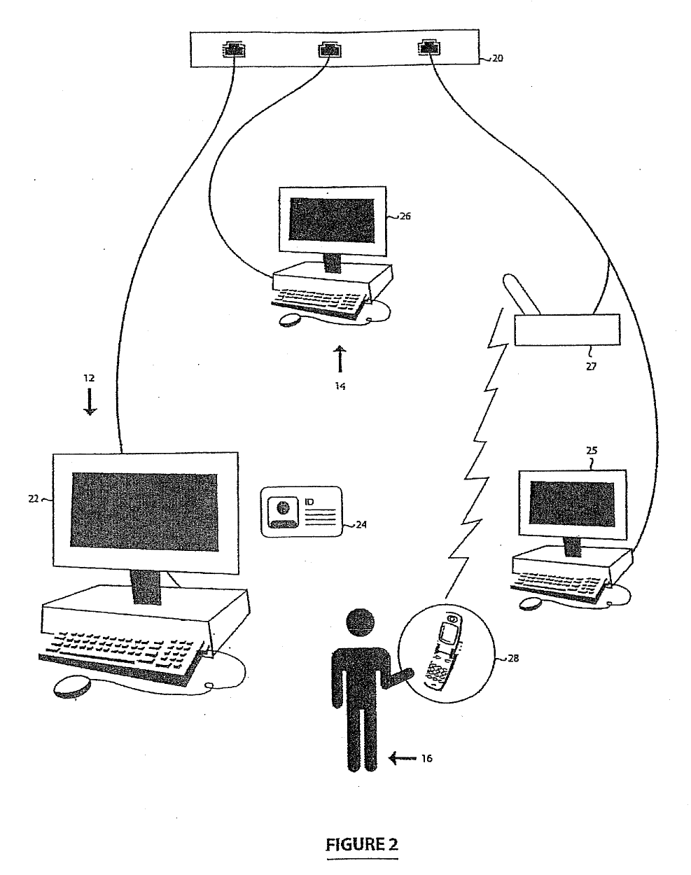

By way of illustration, an electronic implementation of the network used to implement the system 10 via the Internet and World Wide Web is shown in FIG. 2. Every entity involved in the system 10 is connected to the World Wide Web through existing Internet infrastructure (Internet) 20. This may be provided through an available communication means such as a digital subscriber line (DSL) or an equivalent internet service provider (ISP) such as dial-up or cable providers. The verifier 12 has a computer 22 connected to the Internet 20 and in the particular embodiment illustrated in FIG. 2, is verifying a loan application by checking the authenticity of a driver's license 24. It will be appreciated that the system 10 may be implemented over any communication channel or network using any infrastructure supporting such a communication channel or network and the invention should not be limited to the Internet and World Wide Web as illustrated in FIG. 2. For example the system 10 may be implemented over a local area network (LAN), intranet, wide area network (WAN) etc. Any reference herein to a specific network or infrastructure is purely for illustrative purposes and is not intended to limit the invention.

The alert system 14 has a computer (server) 26 with a suitable processor (not shown). The server 26 is connected to a communication network such as the Internet 20 and coordinates the notification and alert procedures of the alert system 14. The server 26 includes an interface to enable a human to interact with the alert system 14. For example, the interface may comprise a website or other means for communicating with the alert system 14. The subscriber 16 is preferably notified by receiving both an Email message accessible via a personal computer 25 and by receiving a second message such as a text message via a wireless device 28. However it will be appreciated the subscriber 16 may also receive a notification message via an Email message only, a text message only or may receive any number of notification messages via any number of acceptable devices. According to the example shown in FIG. 2, a wireless service provider 27 is connected to the Internet 20 and communicates to the wireless device 28 by wireless transmission and to the personal computer 25 via the Internet 20 or similar computer network.

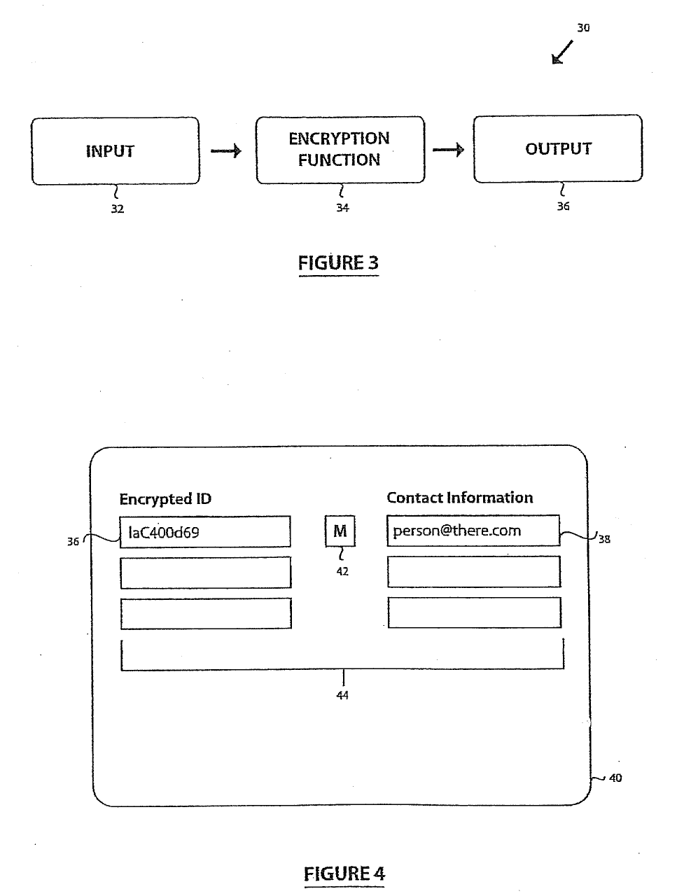

The server 26 may include an encryption module 30 to enable the encryption of data for secure storage. FIG. 3 shows a functional representation of an encryption module 30. The encryption module 30 applies an encryption function 34 to an input 32 to generate an encrypted output 36. The input 32 generally comprises data which is to be securely stored on the server 26. Once the input 32 is converted into an encrypted output 36, the input 32 is preferably deleted and cannot be retrieved. Thus, even if the database 40 is accessed by an unauthorized party, only encrypted information as opposed to authentic identification data can be accessed. It will be appreciated that the encryption module 30 may reside on the server 26 or may be implemented separately as desired.

Data stored by the alert system 14 is preferably stored in a storage device, such as a database 40, shown in FIG. 4. Preferably, an encrypted output 36 is stored with an indicator 42 and associated contact information 38. This group of information will hereinafter be referred to as an entry 44. The contact information stored in the database 40 can be used by the alert system 14 for notifying subscribers 16 by way of a query related to the use of their identification data. A person skilled in the art would understand that many entries 44 can be stored in the database 40. The indicator 42 can be classified as an “M” which means that the entry 44 is matched or a “U” which means the entry 44 is unmatched. If classified as matched, the entry 44 has been entered into the database 40 by the alert system 14 and corresponds to a registered subscriber 16, wherein the alert system 14 can contact that subscriber 16 if that the securely stored information is part of a query made by a verifier 12. If classified as unmatched, the entry 44 is normally incomplete, and has been entered into the database 40 by the alert system 14 upon receipt of a query from a verifier 12 that does not relate to a registered subscriber 16. In this case, the unmatched entry 44 may be retained for other purposes as discussed below.

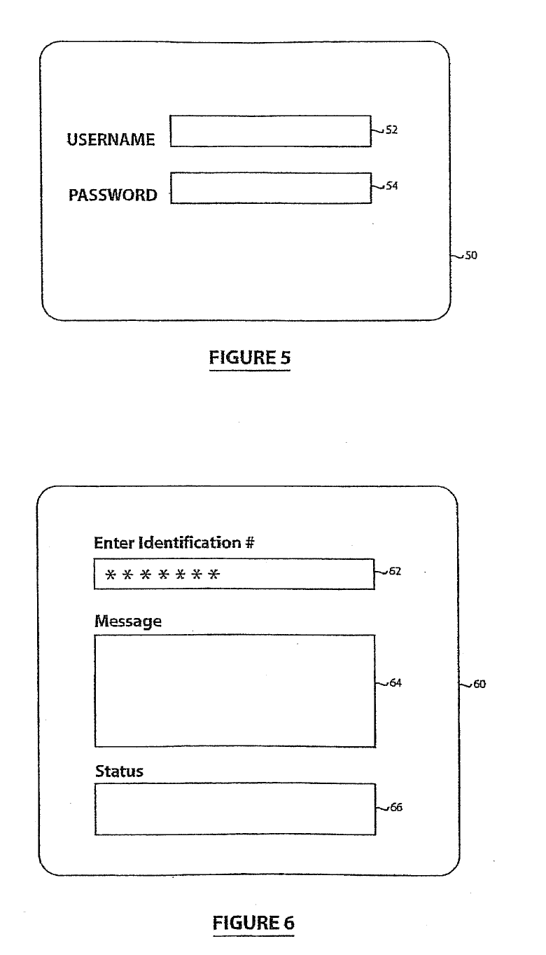

A verifier 12 can query and interact with the alert system 14 through various interfaces. A login interface 50 is shown in FIG. 5 and a verification interface 60 is shown in FIG. 6. The interfaces 50, 60 may be accessed by the verifier 12 via an application program interface (API) which is loaded on their computer 22 once they have registered with the alert system 14 or via a website hosted by the server 26. The login interface 50 includes a username entry box 52 and a password entry box 54. The login interface 50 is used to provide access to the verification interface 60 and preferably provides secure access such as through a secure sockets layer (SSL) connection. The verification interface 60 is also preferably implemented using a secure connection to the alert system 14 such as through an SSL connection.

The verification interface 60 may be provided by the API or via the website hosted by the server 26. The verification interface 60 has an identification number entry box 62, a message entry box 64, a status box 66 and is supported by the encryption module 30. It will be appreciated that the interfaces 50, 60 depicted in the figures are intended only for illustration purposes and that any interface that provides a similar functionality can be provided by the API or the website hosted by the server 26. It will also be appreciated that the interfaces 50, 60 may be implemented in various languages to facilitate verification and notification between subscribers and verifiers of different languages. For example, interfaces 50,60 may include language translation functionality for allowing a verification in one language to appear as a notification in another language.

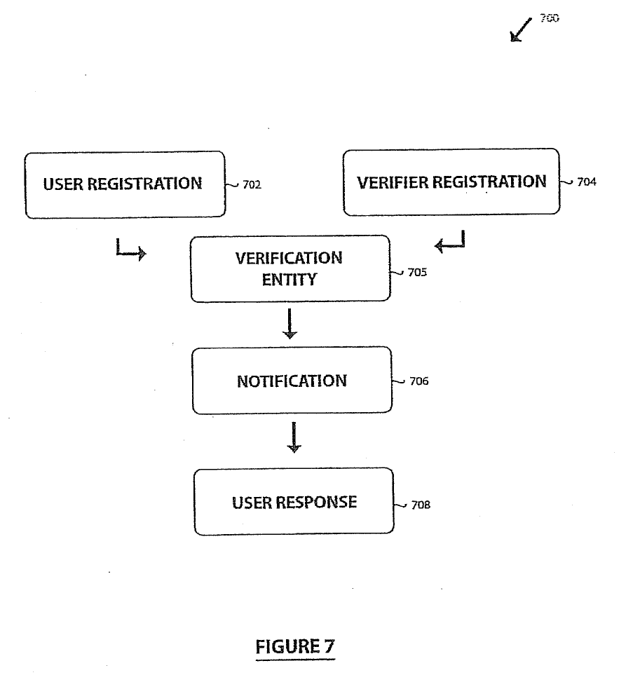

The general steps involved in the notification and alert procedure 700 are illustrated in FIG. 7. The database 40 is built by collecting entries 44. These entries 44 are collected during the subscriber registration procedure 702. The database 40 is accessed by a verifier 12 once they have completed the verifier registration procedure 704. The registration procedures occur using a verification entity 705 external to the system 10. The verification entity 705 receives a request for verification along with the entity's information and verifies the identity of an entity trying to register with the alert system 14 and indicates to the alert system 14 whether or not the entity trying to register has supplied valid information. With a populated database 40, the notification procedure 706 can be executed which encourages and facilitates the subscriber response procedure 708.

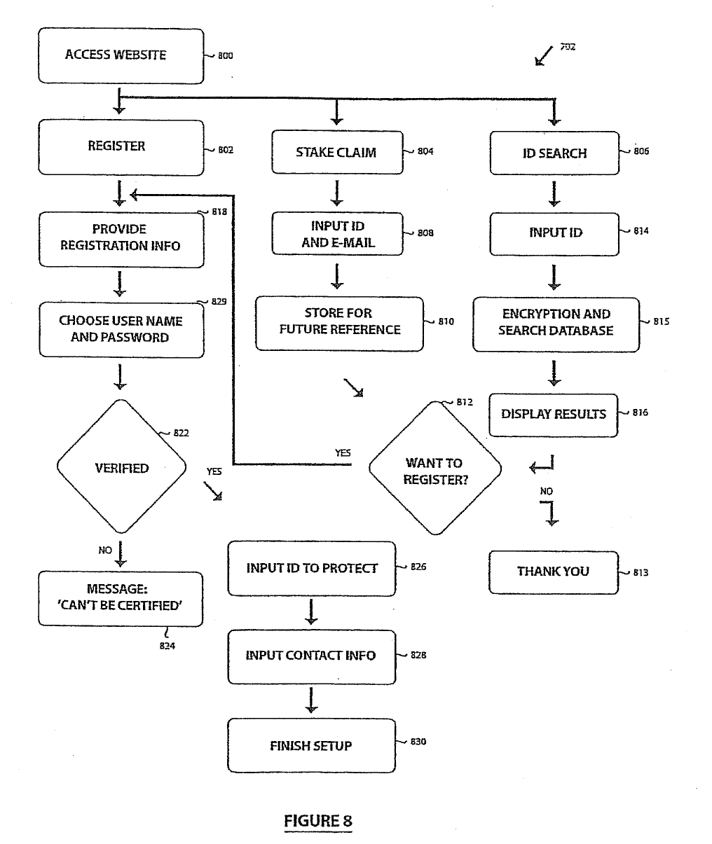

The subscriber registration procedure 702 is illustrated in FIG. 8. To register with the alert system 14, the subscriber 16 may begin by communicating with the alert system 14, preferably by accessing a website hosted by the server 800. The website is preferably accessed securely using a secure connection such as an SSL connection to ensure the information provided during the registration procedure 702 is kept secure. It will be appreciated that the website may be accessed by some other party on behalf of the subscriber 16 if permission is so granted. Upon communication with the alert system, the subscriber 16 is presented with a set of options if applicable, or can directly register with the alert system 14.

In this example, upon accessing the website 800 the subscriber 16 has three options which are: to begin the registration procedure 802, “stake your claim” 804 or to do an identification search 806. The “stake your claim” option 804 is a service which may be provided by the alert system 14 to unregistered users to ensure that other parties cannot register with the alert system 14 using their identification data. The identification search option 806 is a service which may be provided by the alert system 14 to allow unregistered users the opportunity to submit a query to determine whether or not an identification number corresponding to their personal information has been filed as unmatched in the database and therefore an attempt has been made by a verifier 12 to verify that particular identification number.

To “stake your claim”, the unregistered user may submit a identification number corresponding to a piece of personal information (i.e. a credit card number etc.) as well as contact information to the website 808 which uses the encryption module 30 to generate an output 36 for submission to the database 40. The identification number is stored for future reference such that if another party attempts to register that number, both parties are notified of the dispute which should be dealt with before either party can register with the alert system 14. The unregistered user is then asked whether they want to subscribe to the service 812. If they choose “No” then the system 10 thanks them for the inquiry 813 and asks them to consider registering in the future. If they choose “Yes” then the registration option 802 is automatically executed.

If an unregistered user chooses to perform an identification search 806, they input the identification number of interest 814 and the system encrypts the number and searches the database 40 for any unmatched entries that contain the encrypted number 815. This allows an unregistered user to identify whether any verifier 12 has attempted to validate a transaction using their identification. Any matches are displayed 816 to the unregistered user and they are asked whether they would like to register 812 based on the activity which has occurred using their identification. If they choose “No”, then the system 10 thanks them for the inquiry 813 and asks them to consider registering in the future. If they choose “Yes” then the registration option 802 is automatically executed.

Depending upon the choices presented by the alert system 14, the registration option 802 is either presented automatically or is initially chosen by the potential subscriber 16 of the alert system 14. The subscriber 16 provides a set of information required by the alert system 818 to allow the alert system 14 to determine the authenticity of the identity of the potential subscriber 16. In this example, the alert system 14 would generate and send a registered letter to the subscriber 16 to authenticate with a verification entity 705. The information preferably includes a name, address, phone number and payment method. The subscriber 16 can also provide a desired username and password 820 if required.

Using the information submitted, the alert system 14 preferably generates a unique reference number and issue a letter addressed to the subscriber 16. The letter is preferably sent by registered mail. The subscriber 16 will typically be requested to present photo identification to pick up the registered letter, and thereby have access to the reference number. The subscriber 16 then submits this reference number to the alert system 16 to authenticate the registration of the subscriber 16.

In this example, the subscriber 16 takes the registered letter to the verification entity 705 with the reference number, proof of identity and the identification being verified. The verification entity 705 can be any trusted third party verifying agent such as the local police or other government agency. The manual verification allows a trusted third party to validate the verification. The verification entity 705 communicates with the alert system 14 to indicate whether or not the verification was successful 822. If verification is successful, the verification entity 705 sends the identification number to the alert system 14 for input into the system. If the verification is unsuccessful, the verification entity sends an error notification to the alert system 14. Although the subscriber verification procedure described herein is done manually with a registered letter sent to the subscriber 16 who would typically take that registered letter to the verification entity 705, it will be appreciated that the verification procedure may alternatively be done electronically. For example, electronic verification can be implemented using a trusted and secure verification entity 705 which is communicated with via a telephone, the Internet or other communication media. It will further be appreciated that verification may be accomplished without the use of a verification entity 705 wherein the reference number obtained upon receipt of the registered letter can be communicated to the alert system 14 by the subscriber 16 thereby verifying the registration.

If the verification entity 705 rejects the registration, the alert system 14 provides a message indicating that the subscriber 16 cannot be registered 824. If the verification entity 705 authorizes the registration, the subscriber 16 is asked to input the identification number(s) they want to protect 826 and the alert system 14 stores this information with the contact information in the database 40. Preferably, the alert system 14 deletes the information provided during step 818 so that no sensitive information is stored. In this example, the subscriber 16 would input the number of their issued driver's license 24. The subscriber 16 may also wish to protect multiple identification numbers or to create sub-accounts involving dependants such as minors or for deceased relatives. The alert system 14 would typically allow the subscriber 16 to protect any number of identification numbers as well as monitoring the identities of dependants or the deceased by offering sub-accounts as an enhanced service to their account. The subscriber 16 is then asked to input a desired contact information 828. The contact information can be a phone number, email address or any other contact information but for maximum anonymity it is most desirable to provide an anonymous email address which cannot be linked to any name or address. In this example, the driver's license number is encrypted and stored with the contact information in the database 40.

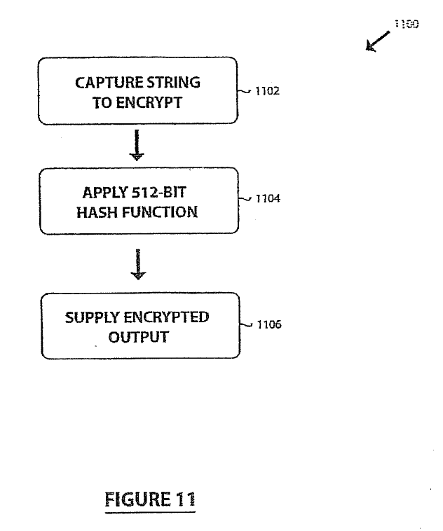

When encryption of the data is used by the alert system 14, the encryption procedure 1100 shown in FIG. 11 may be used. Following submission of the identification number 826, the encryption module 30 captures the string to be encrypted 1102. To encrypt the string, the encryption module 30 in the present example applies a 512-bit hash function 1104. This hash function takes the string which is of an arbitrary finite length and maps it to a string of a fixed 512-bit length 1106. The encrypted value 36 is a compact representation of the input string 32 and can be used as if it were uniquely identifiable with that string. Therefore the encrypted output 36 is unique to the input 32 but does not contain the actual identification number, in this case the actual driver's license number. However a portion of the identification number such as the last 4 digits may be retained to indicate to the customer which identification number has been used. After encryption, the input string 32 is deleted and the output 36 which is an encrypted string is saved in the database 40.

Preferably, the encryption module 30 generates a multiple field hash of the particular identification number. For example, a three field hash may be used, the three fields corresponding to the issuer of the identification, the type of identification, and the identification number itself. In the example described herein, a three field hash would include the government body as issuer, driver's license as type, and the particular number unique to the card 24 respectively. A multiple field hash may be used to better distinguish between different identification pieces that have similar numbers. For example, by including a hash of both the issuer and type, two driver's licenses in different states and provinces having the same number are still unique. Any number of hash fields can be used depending on the particular use of the system 10.

Referring again to FIG. 8, once the encrypted identification number and contact information has been input into the database 40, the setup is completed 830 and the subscriber 16 is now registered. It will be appreciated that the subscriber registration procedure 702 may also be done through other media other than an Internet based website such as the telephone and shall not be limited to such methods. It will also be appreciated that although the encryption module 30 herein applies a one-way 512-bit hash function 1104, any encryption method (E.g. public-key encryption, two-way hash functions etc.) may be used to enable secure communication and storage. Furthermore, any reference to specific security measures particularly the encryption method described herein is provided for illustrative purposes only and is not intended to limit the invention.

However, in the preferred embodiment of the present invention described herein, one-way encryption is preferred. One-way encryption stores information in an encrypted form and contains no function for decrypting the information to its original state. According to the example described herein, incoming queries are also in their encrypted form and thus compared to the stored encrypted value. This is preferable as only the encrypted versions of the information are stored and in the event of unauthorized access to the stored information in the database 40, only an encrypted version (and not the actual identification number) can be fraudulently obtained.

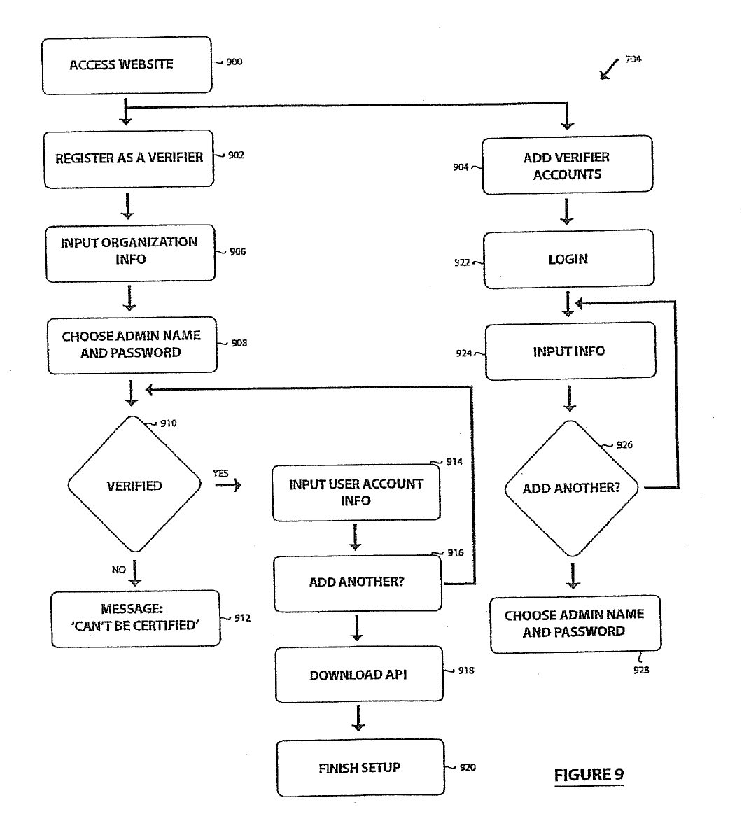

The verifier registration procedure 704 is shown in FIG. 9. To register with the alert system 14, the subscriber 16 would typically begin by communicating with the alert system 14, preferably by accessing a website hosted by the server 900. The website is preferably accessed securely using a secure connection such as an SSL connection to ensure the information provided during the registration procedure 704 is kept secure. The website is accessed through a secure connection such as an SSL connection to ensure the information provided during the registration procedure 704 is kept secure. Similar to the subscriber registration procedure 702, upon communication with the alert system 14, the verifier may be presented with a list of options or may proceed directly to the registration procedure. In this example, upon accessing the website 900 the verifier 12 has two options. Firstly, if the verifier 12 has not registered with the alert system 14, they can choose to register 902. If the verifier 12 has been registered previously, they can also choose to add additional verifier accounts 904.

When the verifier 12 chooses to register 902, they are first asked to provide information regarding their organization 906 for verification purposes. The information provided preferably includes but is not limited to an organization name, address, phone number and payment information. If the organization is a single person, then the organization name is simply their own name. The verifier 12 may then choose an administrative username and password 908. Each account has one administrative access for modifying and governing the account. If the verifier 12 is a single person then the account would typically have only administrative access.

Using the information submitted, the alert system 14 determines the authenticity of the verifier's information 910. The alert system 14 may automatically approve a verifier 12 in the case of large entities or upon agreements with trusted bodies such as the government or a bank. In other cases, the alert system 14 may require verification similar to that done for subscribers. For example, the alert system 14 can send a registered letter to the verifier 12. The verifier 12 would typically be required to present photo identification to pick up the registered letter which includes a reference number. The reference number is used by the verifier 12 to inform the alert system 14 that the correct entity has received the registered letter and therefore can be registered. In one example, the verifier 12 supplies the verification entity 705 with the reference number and proof of identity to validate their existence similar to the subscriber verification procedure. Again, although the verification procedure described herein is done manually by the verifier 12 and the verification entity 705, it will be appreciated that secure electronic verification through a third party verification entity may also be used if necessary or required.

In the case of a verifier 12 not pre-authorized by the alert system 14, presentation of the reference number found in the registered letter informs the alert system 14 whether or not the account has been verified 910. If verification has not occurred, the alert system 14 provides a message indicating that the verifier's organization cannot be verified 912. If verification has occurred, the verifier 12 is asked to input the subscriber account information for the administrative subscriber account 914. This information may include but is not limited to a location, contact name and contact information. This information is used by the alert system 14 to attach a message to an alert allowing the subscriber 16 to contact the verifier 12 for authorization purposes or possible disputes.

Preferably, the verifier 12 is next asked whether they would like to add additional verifier accounts other than the administrative one 916. These additional verifier accounts can be provided to employees of the organization who require the ability to verify identification. If the verifier 12 wishes to add additional accounts, the input procedure 914 is repeated. Steps 914 and 916 are repeated for each additional verifier account that is required. Once the verifier 12 does not want to add any more additional verifier accounts, it is informed that additional verifier accounts can be added at a later date by accessing the website and choosing that option 904. With the account(s) set up, the verifier 12 is instructed to download the application program interface (API) 918 from the alert system 14. It will be appreciated that the API may also be loaded on the computer 22 of the verifier 12 via a recordable medium such as a compact disc and does not necessarily need to be acquired via a website. The API includes the information entry interface 60 supported by the encryption module 30. The verifier 12 can run the API directly from their computer 22 to verify identification or can access the verification interface 60 by accessing the website. Once the API has been acquired, the registration setup is finished 920. It will be appreciated that the verifier registration procedure 704 may also be done through media other than an Internet based website such as via the telephone and shall not be limited to such methods.

In this example, upon accessing the website 900 and if the verifier 12 has previously been registered and has administrative access, they can choose to add additional verifier accounts 904. The verifier 12 would typically provide an administrative username and password to login 922. The verifier 12 then inputs the required information 924 for the first new verifier account. The information may include but is not limited to location, name and contact information similar to during the registration procedure. The verifier 12 is then asked whether or not they would like to add another account 926. If they wish to add another account, steps 924 and 926 are repeated. When the verifier 12 has finished adding new accounts, they would typically logout 928. The login information, including the username and password is protected during storage to prevent fraudulent access to the alert system 14. This can be accomplished using encryption or other security methods as described above. In one embodiment, the passwords are one-way encrypted using the encryption module 30 so that the actual password entered by the verifier 12 is not stored by the alert system 14. It will be appreciated that any password protection method may be used and should not be limited to one-way encryption.

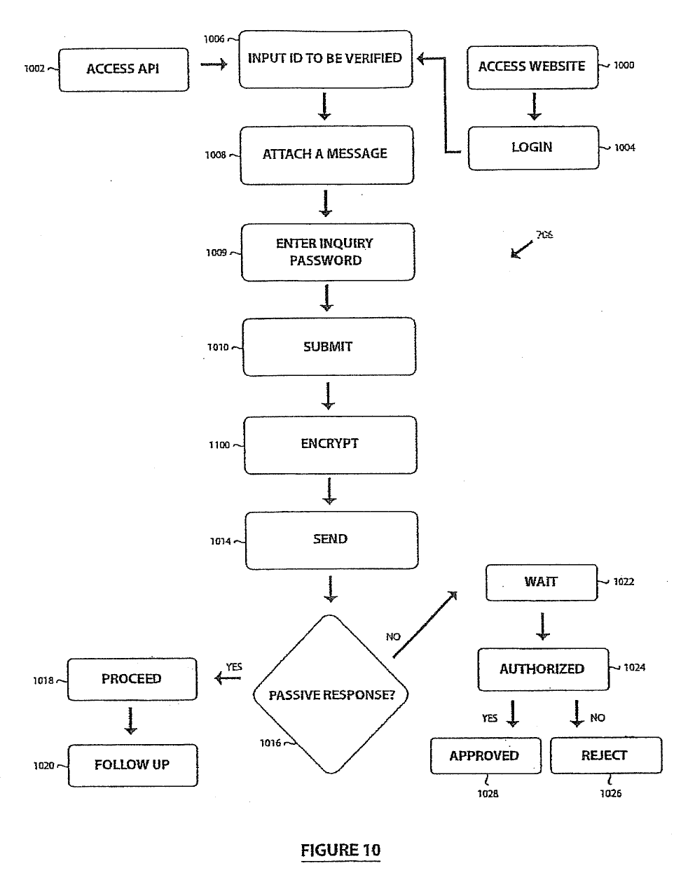

When a verifier 12 has been registered with the alert system 12, they can use the system 10 to verify whether a person providing their identification 24 is the authorized owner of that identification 24. A typical notification procedure 706 is shown in FIG. 10. The verifier 12 begins by either accessing the website 1000 if they do not wish to use the API or do not have a copy or by accessing the API from their location 1002 via their computer 22. If the verifier 12 chooses to perform the notification procedure 706 by accessing the website 1000 they would typically be required to first provide the username and password and login 1004.

At this point, either the website or the API launches the information entry interface 60 and the verifier 12 inputs the identification number to be verified 1006. The identification number may in one example be acquired from the driver's license 24 provided to the verifier 12. The interface 60 then allows the verifier 12 to attach a message 1008 which may be displayed to the subscriber 16 upon receiving notification. In this example, by default, the message may include who is sending the notification and their contact information to enable a response, but the verifier 12 can choose to provide additional details in the message at this point. At this point, the verifier 12 indicates whether a passive or active response is required for authorization.

To enhance security, the alert system 14 can instruct the verifier 12 to enter a password provided by the alert system 14 in the API for each verification 1009. In this example, the password is embedded in an image on the interface 60 requiring a verifier 12 to extract the password from the image. The password is typically distorted such that it cannot be read by optical character recognition (OCR) methods thereby preventing automated mass-verification inquiries. Therefore the alert system 14 can allow the verifier 12 to authorize each individual verification inquiry to provide further security to the alert system 14. The verifier 12 then submits the notification 1010, and in this example, the identification number is encrypted 1100 before it is sent to the server 1014. It will be appreciated that other methods for providing a verification password may be used and the invention should not be limited to image embedded passwords.

If the alert system 14 utilizes encryption, any identification numbers stored by the alert system 14 are encrypted using the same encryption procedure 1100 applied during registration. Therefore if, using the present example, the driver's license number 24 is stored in the database 40 by a registered subscriber 16, the encrypted output 36 can be compared to the encrypted value sent to the alert system 14 in step 1014. The alert system 14 preferably compares and stores encrypted identification numbers providing security from fraudulent activities such as “hacking” into the database 40 by unauthorized personnel since no sensitive information is actually stored by the database 40.

In the next step, the subscriber 16 is notified of the use of identification data belonging to them. For example, in one embodiment, the notification is sent to the subscriber 16 via an Email notification through the Internet 20 which can be accessed through the personal computer 25 as well as by sending a message via wireless transmission to a wireless device 28. In one embodiment, to help prevent mass-enquiries via the interface 60, a quota is tracked by the alert system 14 such that only registered verifiers 12 who have not exceeded their quota can initiate a notification. The quotas are reasonably implemented such that the quota would typically only be exceeded through unauthorized mass-enquiries. This prevents the subscriber 16 from receiving excessive, unnecessary notifications generally known as “SPAM”.

In this particular example, to enable receipt of the wireless message, the wireless service provider 27 transmits a signal to the subscriber's wireless device 28. If the verifier 12 indicated that a passive response is required by the subscriber 16, then they may proceed with the transaction 1018 and the authorization will follow up 1020 at a later time. This can occur when the authorization procedure occurs over a fixed period of time and the notification procedure 706 is only a part of the authorization. For example, a passive response may be desirable for mortgage approvals, loan approvals, or job applications. If the verifier 12 indicated that an active response is required by the subscriber 16, they may wait for the response 1022 before proceeding with the transaction.

An active response can be required for more immediate authorization procedures such as credit card purchases where the merchant requires a substantially instant approval to approve the transaction. The active response is particularly relevant to on-line transactions such as purchases using a credit card. The subscriber 16 would be capable of receiving the Email notification since they are already on-line therefore allowing immediate response to the notification.

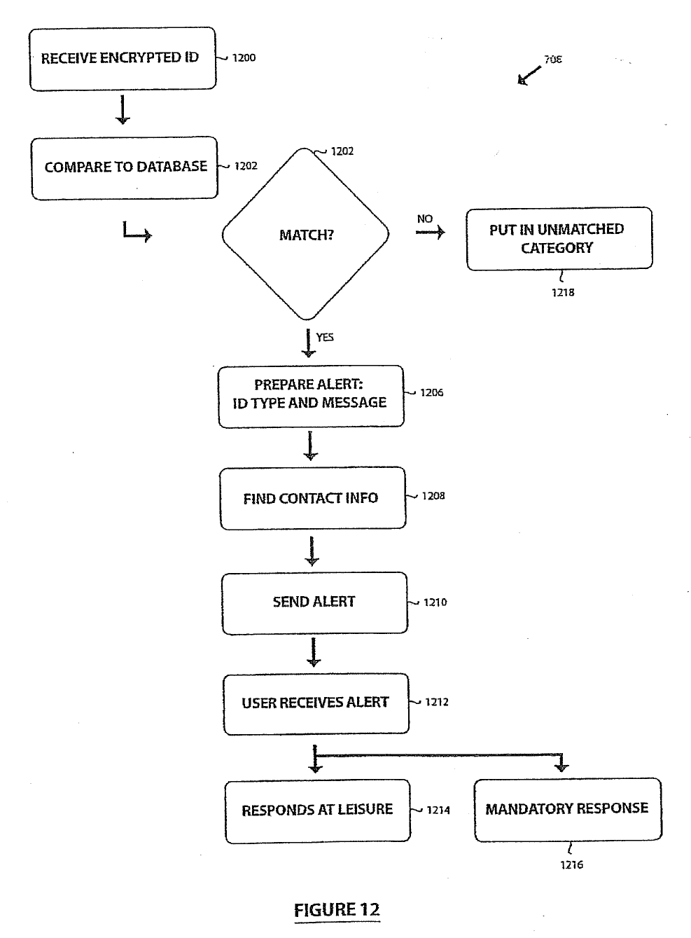

Making reference now to FIG. 12, an example of the subscriber response procedure 708 is shown. The response procedure 708 begins with the alert system 14 receiving the incoming identification number 1200, preferably in an encrypted form as in this example. This number is compared to the listed numbers in the database 1202 to indicate whether or not there is a match 1204. If the identification number matches, the alert system 14 prepares an alert 1206. In this example, the portion of the identification number that was retained indicates the type of identification being used. The alert in this case includes a message to the subscriber that for example “the identification number ending with 1234” (the portion of the number retained) is being used for verification by the name supplied by the verifier 12 and they can be contacted at the contact information provided by the verifier 12. The message may also indicate if appropriate, whether or not an immediate response is required. The contact information associated with the matched entry 44 is identified 1208 and the message is sent 1210 to the contact information 38.

In one embodiment, the subscriber 16 may receive the alert 1212 by Email and additionally by their wireless device 28 and if the response is intended to be passive, they may respond at their leisure 1214 or if the response is intended to be active, a mandatory response is required 1216. The subscriber 16 can respond to the alert by any method they choose, and may be dictated by the nature of the contact information provided by the verifier 12. For instance, if the verifier 12 supplies an Email address as their contact information, the subscriber 16 may be required to locate a computer with such capabilities if their wireless device 28 does not support Email. Alternatively, if the transaction is an on-line transaction, the notification may be received instantly to the Email address and the subscriber 16 can respond immediately since they would typically be connected to the Internet 20 to initiate the transaction.

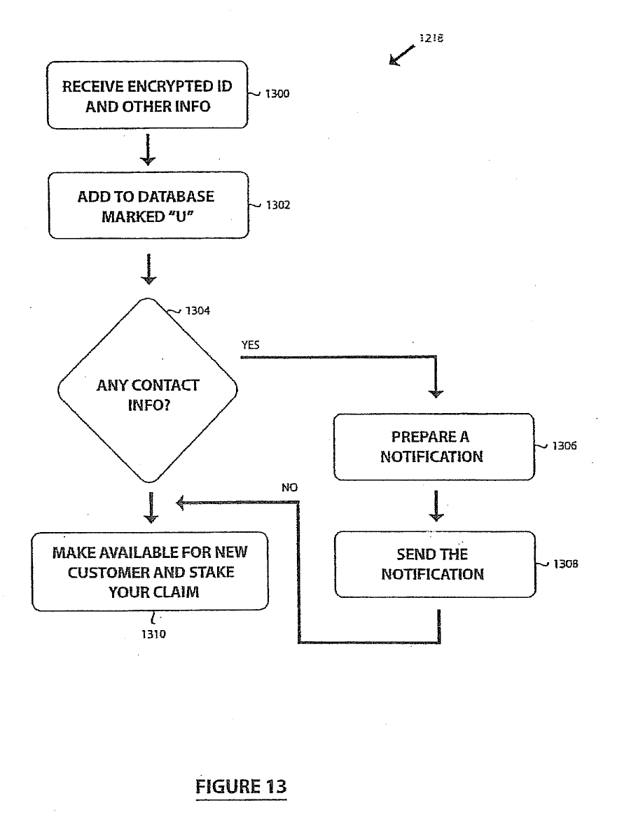

The next step involves matching the incoming identification data with data found in the database 40. In this particular example, if the alert system 14 cannot find a match for the incoming encrypted identification number, it may enter the encrypted value in the database 40 and mark it as unmatched 1218. The indicator 42 would typically be marked as a “U”. This procedure 1218 is shown in FIG. 13. The unmatched procedure 1218 begins by receiving the encrypted identification number and any other information that may have been supplied with the identification number 1300. An entry 44 is then made in the database 40 with the entry 44 marked “U” 1302. The information is checked to determine whether or not any contact information was supplied 1304. If there was contact information supplied, the alert system 14 prepares a notification 1306 and sends this notification to the contact information 1308. This notification indicates that a piece of the person's identification has been used and that if they want to obtain the alert service they can follow the indicated directions. Once the notification is sent 1308 or if there was no contact information found, the entry is made available in the database 40 for future “stake your claim” and unregistered customer searches 1310.

Referring again to FIG. 10, the notification procedure 706 can finish once the response procedure 708 has occurred. This is most critical in the case of an active response. The verifier 12 has been waiting for a response 1022 and would typically eventually receive an authorization from the subscriber 16 or a rejection from the alert system 14 due to an unmatched entry or if a prescribed amount of time has elapsed 1024. If the transaction has not been authorized, it may be rejected 1026 by the verifier 12. If the transaction has been authorized via approval from the subscriber 16, the transaction is approved 1028 by the verifier 12.

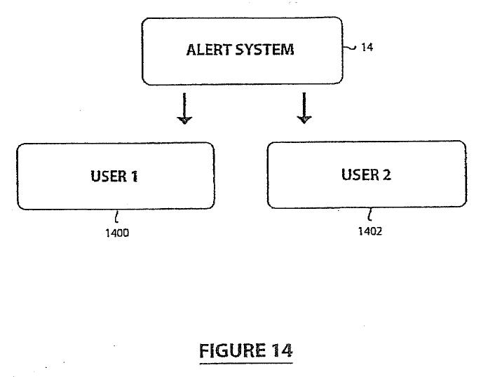

In another embodiment of the present invention, the system 10 may be implemented to allow the transmission of sensitive information between various subscribers 16 as shown in FIG. 14. The security incorporated into the alert system 14 is used to verify that the second subscriber who is receiving the sensitive information from the first subscriber is the correct recipient. The notification received by the second subscriber may include contact information to contact the first subscriber for further conversation. It will be appreciated that the second embodiment may be achieved using the secure transmission and storage of subscriber information as well as the notification procedure described herein according to example given illustrating the present invention and need not be reiterated.

In yet another embodiment of the present invention, the system 10 may be implemented for security tracking such as for using access codes. For example, the verifier 12 according to this embodiment can be a security access card and when that card is used to gain access, (to a building, vehicle, safe deposit box etc.) a verification and notification procedure as described herein according to the example given illustrating the present invention is initiated such that the subscriber 16 may receive a notification of their security access card being used for access a particular zone such as a building or vehicle. Such an embodiment may be suitable for but shall not be limited to buildings with controlled access and can notify the authorized holder of the use of their security access card and to monitor this use. It will be appreciated that the use of the system 10 for building security may use the elements described herein according to the example given illustrating the present invention and these elements need not be reiterated.

In another embodiment, a verifier 12 may also wish to send bulk email correspondence which may include or request sensitive identification information belonging to their customers through a secure channel. By allowing their customers to view the message contained in the bulk email through this secure channel, the customer can be confident that the correspondence originated from a trusted source and that the identity of the verifier 12 has not been misused. The customer can then, for example, proceed to provide sensitive information, if requested, with confidence that the sensitive information may be exchanged with the proper recipient. As well, the verifier 12 can also attempt to ensure that its customers are not misguided through unauthorized correspondence.

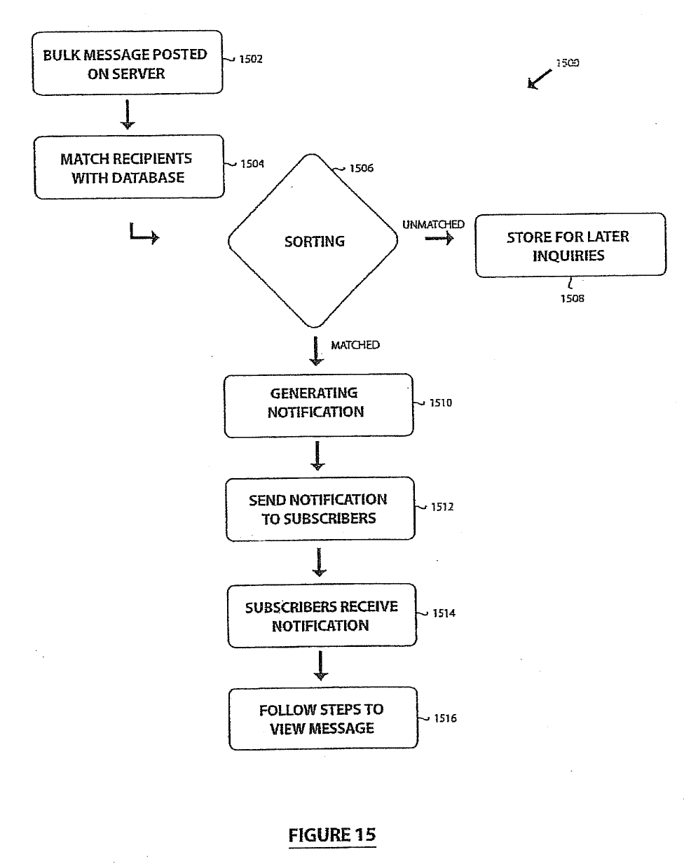

In yet another embodiment of the present invention, the system 10 may be implemented for secure correspondence between verifiers 12 and their customers which may include one or many subscribers 16 using the alert system 14. Referring now to FIG. 15, a secure bulk message posting procedure 1500 is shown.

The verifier 12 may access their account and post a bulk message on the server 1502. This bulk message is intended to be received by a verifier-supplied list of recipients. The verifier 12 may provide an identification number associated with the customer, a contact email address or any suitable information as required by the alert system 14 for verification purposes. These numbers are preferably encrypted using the procedures described above and this encrypted data is compared with the encrypted entries of the database 1504.

The alert system 14 may then perform a sorting procedure 1506 to identify verified subscribers 16 from non-subscribers. Any unmatched entries from the sorting procedure 1506 can be stored in an unmatched database for later inquiry 1508. The matched entries are associated with subscribers 16 and the alert system 14 generates a bulk notification message 1510 which is sent to these subscribers 1512. A subscriber 16 may receive the notification indicating that they have received an email from the indicated verifier 12 and may be given instructions to view the message 1514. The subscriber 16 may then use the notification to follow the steps given to retrieve the message. An exemplary set of steps for retrieving the message would be for the subscriber 16 to follow a hyperlink requiring them to first logon to the server 26, and the alert system 14 would redirect the subscriber 16 to the posted message.

By incorporating the above procedure 1500, the verifier 12 can provide electronic correspondence through a secure channel whereby a subscriber 16 can distinguish between authorized (or legitimate) emails from unauthorized emails they may receive based on the fact that the latter would not have been posted to the alert system 14. The identity of the verifier 12 as well as the identity of the subscriber 16 can therefore be protected while encouraging confidence that electronic correspondence between the two parties 12, 16 can be achieved in a secure fashion.

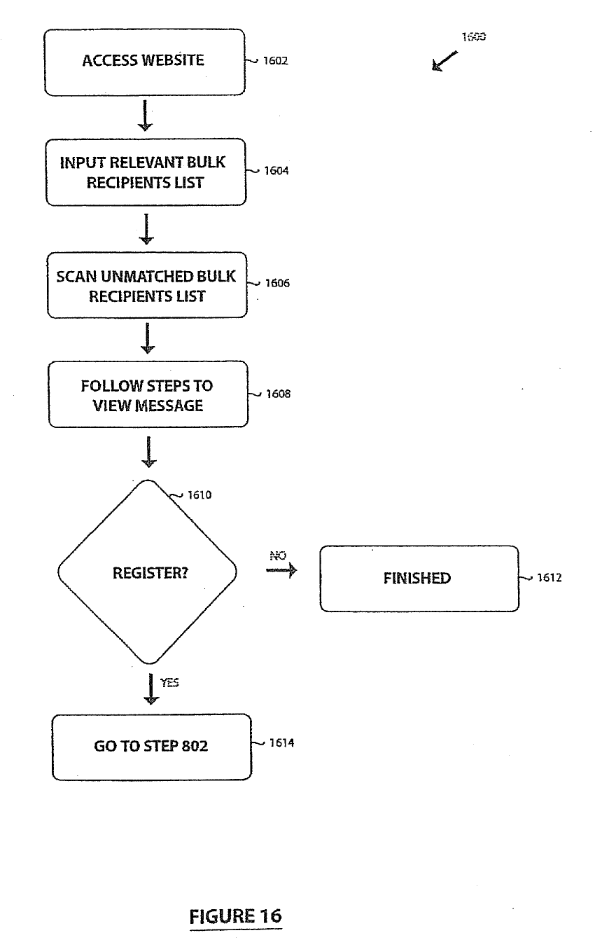

The aforementioned unmatched entries provided by the verifier 12 can be used by the alert system 14 to allow access to unverified users (i.e. non-subscribers) who wish to view the bulk email. The verifier 12 may send a notice to such individuals (or entities) that bulk messages have been securely posted on the alert system 14 and redirect them to the system website. Alternatively, the alert system 14 may provide notice to these individuals that they may receive the message through a secure channel (i.e. the alert system 14). This could be provided by the verifier 12 as an added service to their customers while helping to protect their own identity. A procedure for non-subscribers to inquire about bulk messages 1600 is shown in FIG. 16.

Upon receiving a notification that they were a recipient of a bulk email message, the non-subscriber is directed to access the website 1602. The non-subscriber may then preferably input relevant information 1604 such as the email address in which the bulk email was intended to be sent to or the identification number associated with the verifier 12. It will be appreciated that if the identification number is used, the number would be encrypted by the alert system 14 to allow comparison with encrypted versions of the identification number stored by the alert system 14. For illustrative purposes, it may be assumed that the non-subscriber inputs their email address.

The unmatched bulk recipients list is then scanned by the alert system 1606 and a set of instructions is provided to the non-subscriber if their email address is included in the list. Typically the non-subscriber may be performing this procedure upon receipt of some form of notification. However the list is preferably scanned each time in the event that regular inquiries are desired by the non-subscriber to check for pending bulk email messages.

Upon receiving the set of instructions, the non-subscriber may follow the set of instructions, thereby gaining access to the message sent to them 1608. The non-subscriber may then be asked by the alert system 14 if they would like to register 1610 with the alert system 14 for both secure email purposes and other benefits associated with being a subscriber 16. If the non-subscriber wishes not to register, they would typically finish their session with the website 1612. If they do wish to register they would be redirected to the registration procedure 702, particularly step 802 shown in FIG. 8.

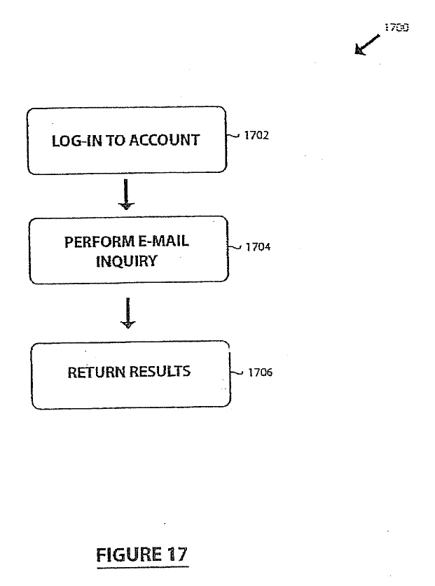

A subscriber 16 may also wish to verify the authenticity of email messages that they perceive to be bulk email correspondence from a legitimate company requesting information. A procedure for performing a bulk message inquiry 1700 is shown in FIG. 17. The subscriber 16 first logs on to their existing account 1702 with the alert system 14 and then performs an email inquiry 1704. This may be done using any suitable information provided by the subscriber 16 such as, but not limited to, the email address from which the email was sent, the company name etc. The alert system 14 may check their database 40 to determine whether or not the information corresponds to a registered verifier 12 and whether or not the bulk message they have received was sent correctly. Any results produced by the alert system 14 are returned to the subscriber 1706. The alert system 14 therefore may provide an additional service to their subscribers 16 to inquire about any email they receive which requires the exchange of sensitive information.

Subscribers 16 may wish to extend the notification capabilities of the alert system 14 to handle other email messages or even the entirety of messages they receive at a specific email address. In yet another embodiment of the present invention, the alert system 14 may offer as an added service, the capability of filtering email to prevent a subscriber 16 from receiving unwanted messages commonly referred to as “SPAM”.

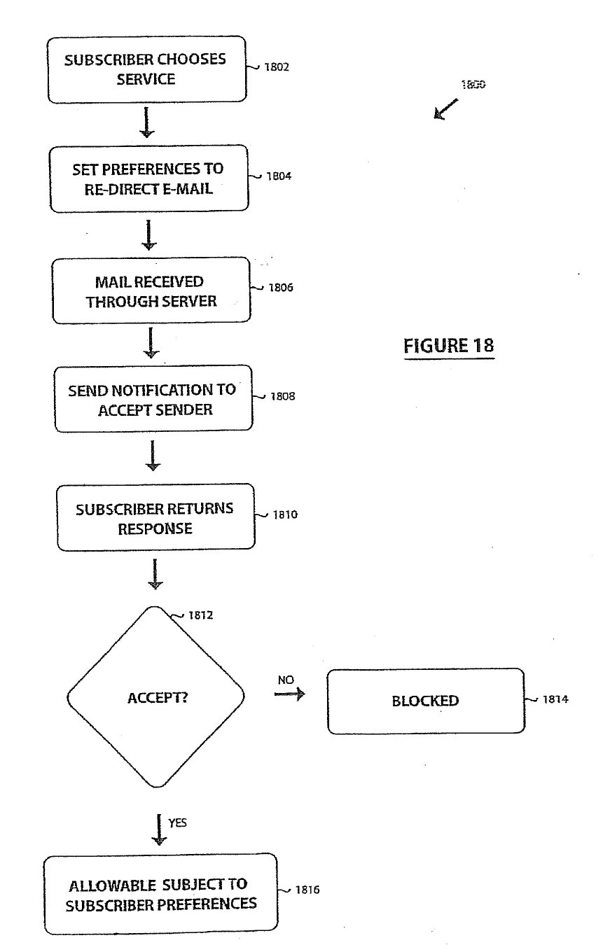

A procedure for filtering a subscriber's email through the alert system 14 is shown in FIG. 18 and is generally denoted numeral 1800. The procedure 1800 is initiated by the subscriber 16 choosing to incorporate the email filtering with their account 1802. The subscriber 16 may simply change their user preferences for re-directing incoming mail through the alert system 1804. The preferences may include varying degrees of filtering and different security levels depending on the needs of the subscriber. Upon activating this preference, the email sent to the specified account, which would preferably be the email address used for the subscriber's contact information, is received by the server 1806 of the alert system 14.

The alert system 14 may notify the subscriber 16 that a particular entity has sent them an email 1808 with an option to accept or block the sender. The subscriber 16 may respond to the notification 1810 to enable the alert system 14 to filter future messages from the particular sender. The alert system 14 may collect the responses and determine whether or not the subscriber 16 wishes to accept future messages from the indicated sender 1812. If the subscriber chooses not to accept, the sender's message is blocked 1814 whereas if the sender is accepted they become an “allowable” sender 1816.

It will be appreciated that the subscriber 16 may be able to impose restrictions to limit acceptance of messages from the sender using criteria such as the number of correspondences received in a specified time period. Alternatively, the criteria may be based on a select list of “keywords” etc. This allows the subscriber 16 and the alert system 14 to impose restrictions on marketing and solicitation which may be of interest to the subscriber 16 such that an undesirable amount or type of incoming email is avoided.

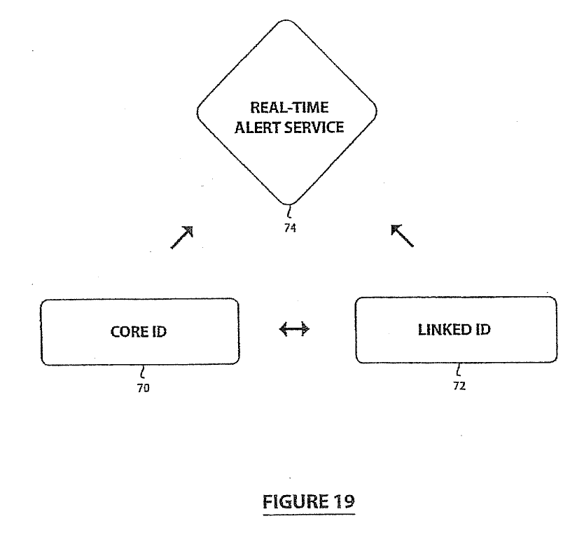

In another embodiment of the present invention, various levels of protection may be defined to not only enable a subscriber to protect a particular piece of identification from the day of subscribing with the alert system 14 onwards, but also activity pertaining to their identity that may have occurred prior to subscribing. An example of varying security levels is shown in FIG. 19. The security levels shown include a core ID level 70, a linked ID level 72 and a real-time alert service level 74.

The core ID level 70 in this embodiment represents the core level of protection. When a subscriber 16 chooses to register with the alert system 14, they may typically provide a core set of identification numbers such as a driver's license, social security number and/or passport number. It is well known that these core identification numbers are typically the primary sources of identification required when verifying one's identity. To establish the core ID level 70, the subscriber 16 would register with the alert system 14 as described herein. Upon subscribing it is preferable to have the subscriber 16 present at least two pieces of core identification. For example, the subscriber may be requested to provide a social insurance number and a driver's license number. However it is most preferable to provide three pieces of core identification to further include, for instance, a passport number. The alert system 14 may proceed to verify the core identification numbers by sending a registered letter to the subscriber 16 (or other suitable method for verification) to ensure that the subscriber 16 is the true owner of the identification number presented, as previously described with respect to the present invention.

The establishment of the core ID level 70 provides the basic service. The subscriber 16 would typically employ the alert system 14 to provide real time alert service 74 also as described above. At the time of subscribing, the alert system 14 in this embodiment would preferably not automatically link other identification numbers such as a credit card number, bank account number, health card number etc. to the core identification. It is conceivable that a properly verified subscriber 16 may wish to link another person's credit card number, for example, to their account such that they may be the individual that receives notification of the use of that credit card number, thereby enabling fraudulent activity through the secure communication channel. This example depends on the situation where the legitimate owner of the credit card has not subscribed to the alert system's service. Nonetheless, to offer the maximum protection for these “other” identification numbers, it is preferable to add a second security level, namely the linked ID level 72.

The linked ID level 72 takes advantage of the above described secure communication channel provided by the alert system 14 between the verifier 12 and the subscriber 16. A subscriber 16 in this embodiment is assumed to have legitimate ownership of the core identification numbers protected by the core ID level 70 upon subscribing. It is generally known that to obtain credit cards, bank accounts etc., a person typically needs to present at least one piece of identification which would be associated with a core set of identification numbers. For instance, to sign up for a credit card, the issuing institution would typically ask for a social insurance number and driver's license number. Since these identification numbers are preferably those which are designated as core identification numbers by the alert system 14, the linked ID level 72 may use the core ID level 70 to add additional identification numbers to a subscriber's account. However, the linked ID level 72 preferably initiates this operation through the verifier 12.

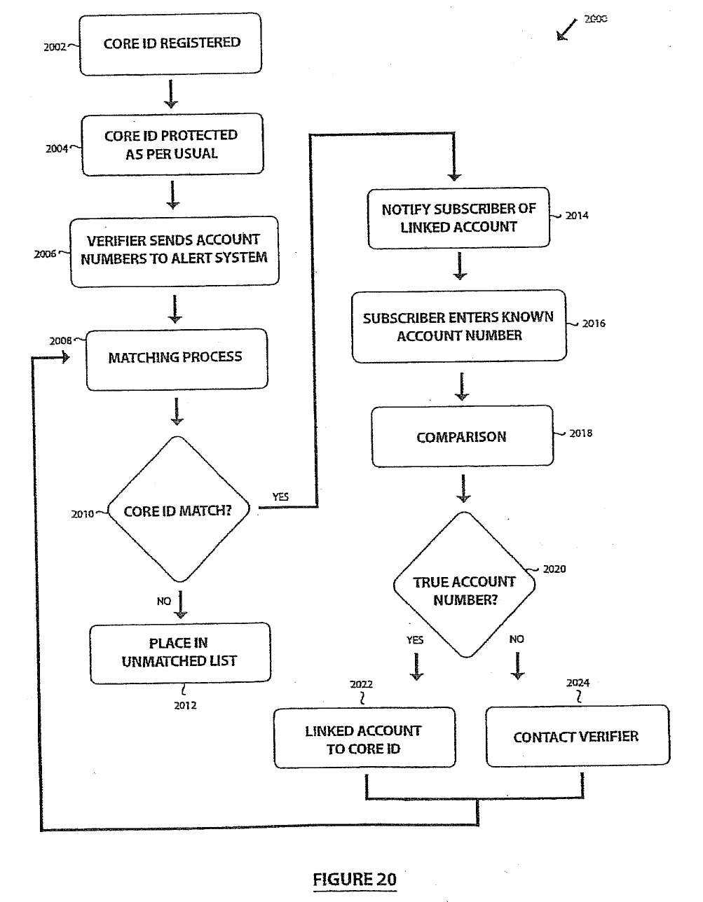

A procedure 2000 for linking a subscriber's other identification numbers with their core identification numbers is shown in FIG. 20. As mentioned above, the linked ID level 72 preferably operates upon registration of the core identification numbers 2002. In this case, the subscriber's account utilizes the real-time alert service level 74 and as such, their core identification continues to utilize the basic protection 2004. It is preferable for the linked ID level 72 to receive a set of account numbers 2006 from a verifier 12 to enable subscribers 16 to protect account numbers held by the verifier 12. In this scenario, it is assumed that the verifier 12 has registered with the alert system 14. The alert system 14 would receive this list of account numbers using any suitable means, preferably by having access to a database that is compatible with its existing database 40, and begin a matching process 2008.

In the preferred case, the database provided by the verifier 12 contains, for each entry (wherein each entry represents a customer), encrypted versions of the account number, and an encrypted version of at least one of the core identification numbers that would expect to be stored at the core ID level 70. According to the secure communication channel described above, the verifier 12 would, for example, use the API which they have obtained upon registration to encrypt a database containing the entries listed above and send this encrypted version of the database to the alert system 14. This would ensure that the actual identification numbers never become available and thus susceptible to fraudulent activity. The alert system 14 would then receive the encrypted database and compare encrypted versions of the core identification numbers with those stored in their database 40. The alert system 14, for each entry, would determine whether or not the account number is linked to existing core identification 2010.

If an entry does not match, the entry would preferably be placed in an unmatched list 2012. This would allow the alert system 14 and/or the verifier 12 to determine which of the verifier's customers do not use the alert system 14. The use of such entries will be discussed later.

Upon matching an entry with a subscriber 16, the alert system 14 may notify the subscriber 16 of the existence of the account in question 2014. A preferable way to notify the subscriber 16 is to send an alert through the real-time alert service level 74 indicating that an account (without divulging the actual number) exists with the applicable institution (the verifier 12). The alert system 14 would preferably ask the subscriber 16 if they would like to link this account number with their service (the subscriber 16 may be encouraged by the verifier 12 to do this as well) wherein through the usual secure means described herein, the subscriber 16 would be asked to enter the account number they know belongs to the account in question 2016.

There may be the case, for example, that a large bank wants to verify their customer's accounts and an account exists that has been opened under a false name. The bank can then use the alert system 14 to not only audit their accounts but also to encourage the use of the alert system 14 and even provide this as an added service to their customers.

The subscriber 16 may enter the account number in any suitable manner but preferably this would take place through the alert system's secure website. This number may be encrypted (if applicable) by the alert system 14, and compared 2018 to the account number provided by the verifier 12. If the encrypted values are matched then the account number known to the subscriber 16 is also the account known to the verifier 12 under the name of the subscriber 16. Therefore since the subscriber 16 is known to be legitimately linked to the core ID level 70, by entering the additional account number, they can verify that existing accounts are legitimate 2020. If the account number is legitimate, the alert system 14 would preferably link this account number with the core ID level 70 by incorporating it into the linked ID level 72. This account number can then utilize the real-time alert service level 74 to obtain live notification of the use of that account number (as described herein). The subscriber 16 therefore may verify account numbers that exist or may have existed in the past as well as accounts opened in their name without consent. In any case, using the herein described secure communication channel, the verifier 12 is able to audit accounts and likewise the subscriber 16 may perform an audit of accounts that may be linked to their core identification.

If the account number entered by the subscriber 16 does not match the account number provided by the verifier 12, the subscriber 16 may be given the opportunity to contact the verifier 12 to investigate the existence of the account 2024. If a subscriber 16 has more than one account with a particular institution, they may be given the option to enter all known account numbers with that institution to avoid unnecessary “false alarms”.

As shown in FIG. 20, the process outlined according to steps 2010-2024 would typically be repeated for each entry in the database provided by the verifier 12 so that each customer they wish to audit is dealt with in turn by the alert system 14.

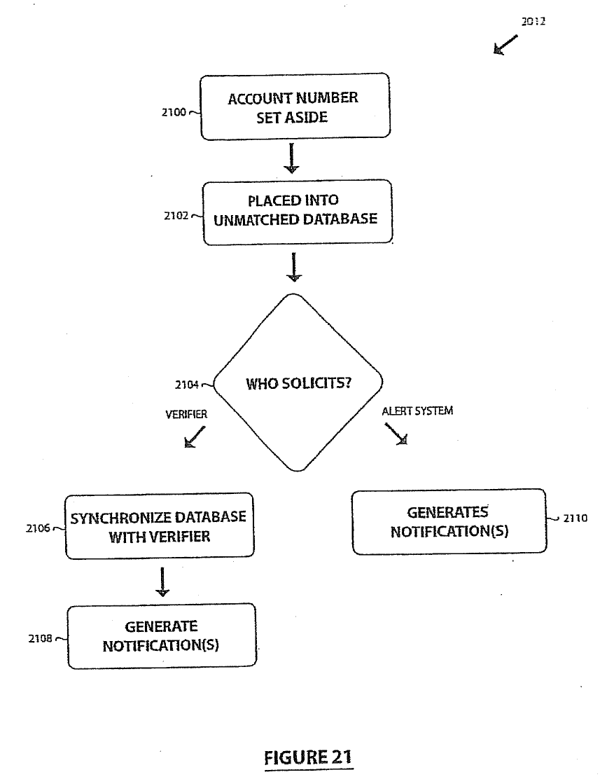

Step 2012 which involves placing unmatched entries into an unmatched list is shown in greater detail in FIG. 21. During the iterative procedure exemplified in FIG. 20, an unmatched account number would preferably be set aside 2100 by the alert system 14 for later solicitation. Most preferably, a separate database of unmatched entries would be generated and populated with these unmatched entries 2102. Upon completion of the matching process 2008 (shown in FIG. 20), the unmatched database may be used to notify the verifier's customers to complete an audit of the account numbers that exist or to offer the alert system's service thereto. The alert system 14 may then determine who may use this unmatched database 2104. If the verifier 12 is willing to be responsible for notifying unmatched customers, the unmatched database may be synchronized with the verifier 2106 to ensure the verifier 12 obtains the necessary information to determine which of their customers currently does not use the alert system 14. In this case they may wish to notify these customers 2108 and encourage use of the alert system 14 as an added service, to complete their audit of existing accounts, or for any other suitable reason.

The verifier 12 may therefore form a partnership with the alert system 14 such that in using the secure communication channel provided by the alert system 14, the verifier 12 can offer added service to their customers while promoting the use of real-time alerts for the customer's benefit. In some cases, it would be most beneficial for the verifier 12 to incorporate the use of the alert system 14 with their own service as a measure of security and ultimately as a form of insurance.

If the alert system 14 is to be responsible for the unmatched entries, they may use the database to contact potential subscribers to promote use of the system on behalf of themselves or in partnership with the verifier 12 and other verifiers.

Using the security levels illustrated in FIG. 19, a secure system is provided that can be used to not only protect the most valuable core identification, but also to link other identification to these core identification numbers to ensure the legitimacy of activity associated with a person's name, core identification, other identification etc. A subscriber 16 can therefore determine accounts that may exist that they are not aware of or may have forgotten about. The subscriber 16 may also link jurisdictional identification numbers such as out-of-province/state driver's licenses to a core driver's license or different social security numbers resulting from dual citizenship. Within the link ID level 72, there may also be sub-links such that a piece of identification can link to identification numbers in the link ID level 72 which in turn are linked to the core ID level 70. In any case, the chain of ownership of all types of identification can be traced back to the legitimate owner, namely the subscriber 16. A verifier 12 can also use the structure shown in FIG. 19 to perform audits on accounts they have or can offer the use of the alert system 14 as an added service or in a partnership to promote the use of the alert system 14 with their customers.

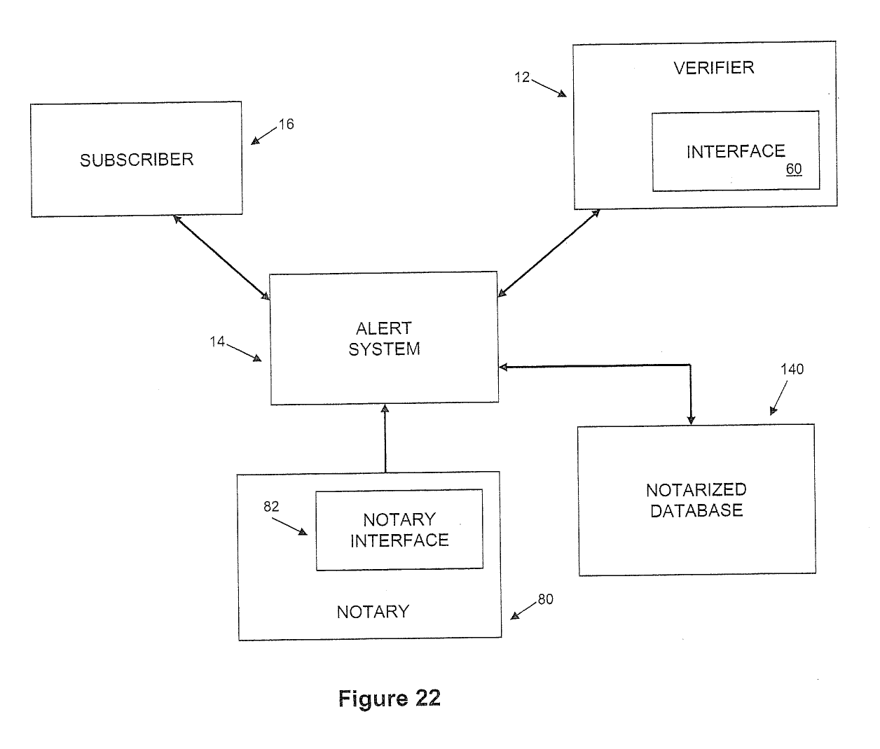

In yet another embodiment, registration of subscribers 12 and verifiers 14 can be performed by a notary 80 as shown in FIG. 22. The notary 80 may be a lawyer or other certified entity that is known by, and registered with the alert system 14. The notary 80 is provided with a notary interface 82 that may comprise an API or be accessible through the alert system's website. The use of registered notaries 80 localizes the point of entry for subscribers 12 and verifiers 16 that wish to register with the alert system 14. The alert system 14 may then be confident that a legal means has been used to authenticate the identity of the entity wishing to register with the system, in an attempt to inhibit fraudulent use of the alert system 14.

The use of a notary 80 also enables the creation of a notarized database 140 of registered subscribers 12 that use the alert system 14. This notarized database 140 stores a list of all encrypted identification numbers that have been registered through the legally recognized notary 80. Any number of notaries 80 may be registered with the alert system 14, and this may depend on, e.g., geographical convenience, co-marketing initiatives between the notaries 80 and the alert system 14, etc.

The notary interface 82 may be any interface that enables the notary 80 to submit a verification confirmation to the alert system 14, and that is capable of performing the encryption function shown in FIG. 3. The identification number is preferably encrypted prior to submission thereof to the alert system 14, so that the encrypted version may be compared with the encrypted version awaiting verification. This also helps to ensure that the subscriber 16 has used a registered notary 80, since only registered notaries 80 are provided access to the notary interface 82 by the alert system.

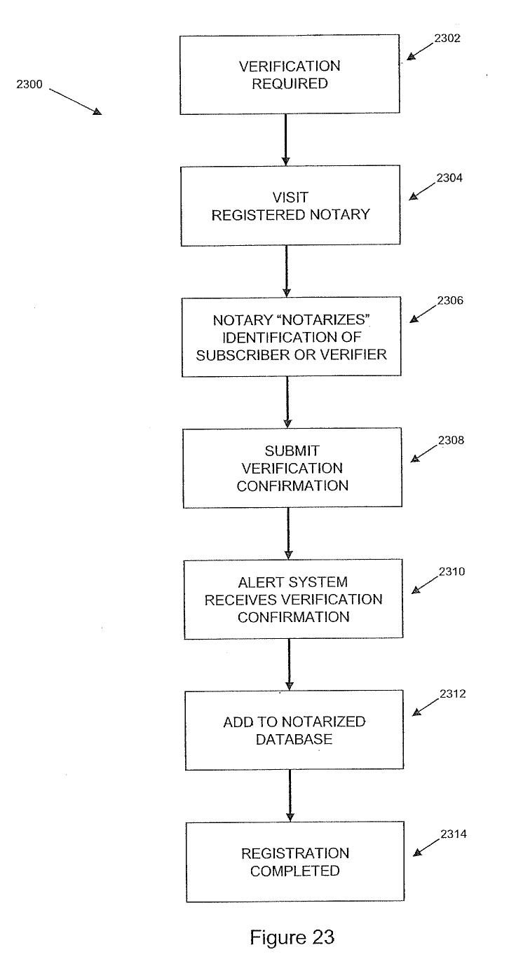

A notarized verification procedure 2300 is shown in FIG. 23. The following exemplifies the registration of a subscriber 16, however, it will be appreciated that a similar procedure may be used to verify the identity of a verifier 12 and a notary 80. When a verification of the subscriber 16 is requested 2302 during the registration procedure 702 described above, the alert system 14 may prompt the subscriber 16 to visit a registered notary 80 in order to complete the registration procedure 702. Preferably, once the subscriber 16 has entered their information and chosen a username and password, the alert system 14 requests that the subscriber 16 visit one of a provided list of registered notaries 80 and notifies the subscriber 16 that their information may be held for a particular number of days (e.g. 3 business days) pending the submission of a verification confirmation by one of the notaries 80.

The subscriber 16 would then visit one of the registered notaries 80 at step 2304. The notary 80 would typically require suitable confirmation of the identity of the subscriber 16, such as photo identification and proof of possession of the identification that the subscriber 16 wishes to protect. When the notary 80 is satisfied that the identification number legally belongs to the subscriber 16, they “notarize” the identification of the subscriber 16 at step 2306 by accessing the notary interface 82 and submitting a verification confirmation at step 2308. This preferably includes the steps of logging onto the notary interface 82 by loading an API or entering a password through a web interface, entering the identification number with personal information related thereto, and executing submission of the confirmation that includes an encryption of the identification number and transmission of this encrypted version with the associated personal information to the alert system 14.

The alert system 14 would then receive the verification confirmation at step 2310, which it can then check against pending registration attempts. Since the identification number has been encrypted at both ends with the same encryption function 34, the notarized confirmation would be accepted, and the alert system 14 would add the subscriber 16 to the notarized database 140 at step 2312, by completing the registration procedure at step 2314.

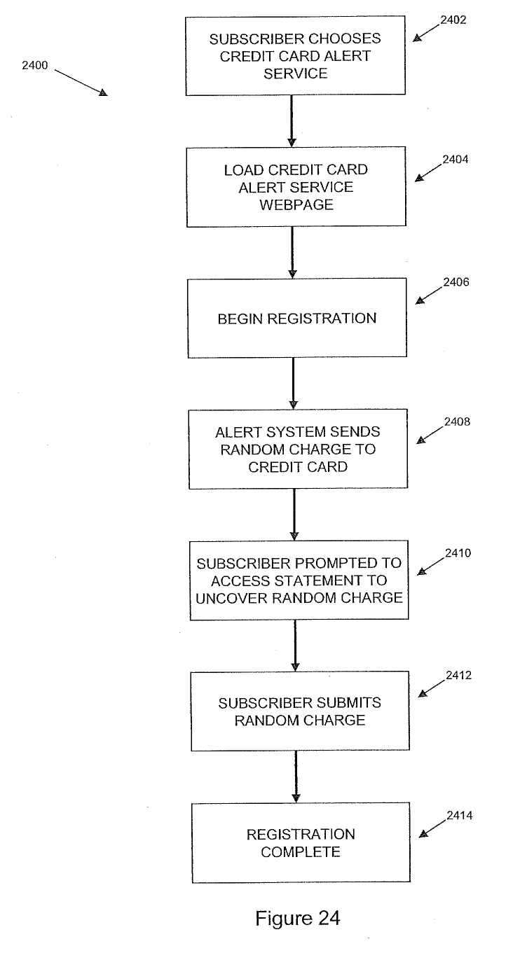

In yet another embodiment, the alert system 14 may be used to provide a separate service for monitoring the use of financial accounts such as credit cards and bank accounts. Such a service may be provided to subscribers 12 who only wish to track the use of their credit and debit cards, or wish to separate the monitoring of these cards from the monitoring of core pieces of identification such as driver's licenses and passports. An example showing the registration of a subscriber 16 for a separate credit card alert service is shown in FIG. 24 and generally denoted by numeral 2400.

In this example, the subscriber 2402 chooses the credit card alert service option at step 2404. This option may be provided through the alert system's website described above, or through a separate website. The credit card alert service webpage would then load at step 2404 and the registration of the subscriber 16 would begin at 2406. Registration preferably begins as described above. However, to verify that the credit card belongs to the subscriber 16, the alert system 14 would add a random charge to credit card at step 2408. The random charge is preferably included as at least part of the registration fee, and is preferably a random value within a predetermined range, e.g., between $4 and $5.

Once the random charge has been added to the credit card being registered, the subscriber 16 would then be prompted to access their credit card statement to uncover the exact amount of the random charge at step 2410. Once the subscriber 16 accesses their statement, and uncovers the amount of the random charge, they would enter this value at step 2412 to complete the registration of their credit card at step 2414.

For example, the alert system 14 may have charged $4.24 to the credit card being registered. If the subscriber legitimately owns the credit card, they are able to access their credit card statement online or when received by mail. This enables them to identify the exact amount that was “randomly” charged to their credit card. The subscriber 16 would then enter this amount (e.g. 4.24) to establish that they legally own the credit card, and to complete the registration process. It will be appreciated that the verification of a bank account may be accomplished using a random deposit which also requires the subscriber 16 to access account information.

It will also be appreciated that the registration of the separate service may alternatively be verified through the notary 80 at the time in which other identification is being verified. This would bypass the random charge procedure 2400, and would verify the subscriber 16 for both the standard monitoring service and the separate service for their financial accounts at the same time. The random charge procedure 2400 may then be used later to add another credit card or bank account number to the separate service.

Alternatively, the separate service may be implemented such that verifiers do not need to have access to the alert system website or API. In such an implementation, the identification numbers would not be encrypted at the verifier 12, but would be sent over a secure connection, e.g. an SSL connection, to the alert system 14, wherein the identification numbers would then be encrypted in order to compare with entries in the database 40 (or 140). This is preferably used for specific application such as verifying credit cards wherein the SSL connection provides an adequate layer of protection, and enables non-registered verifiers to use the alert system 14.

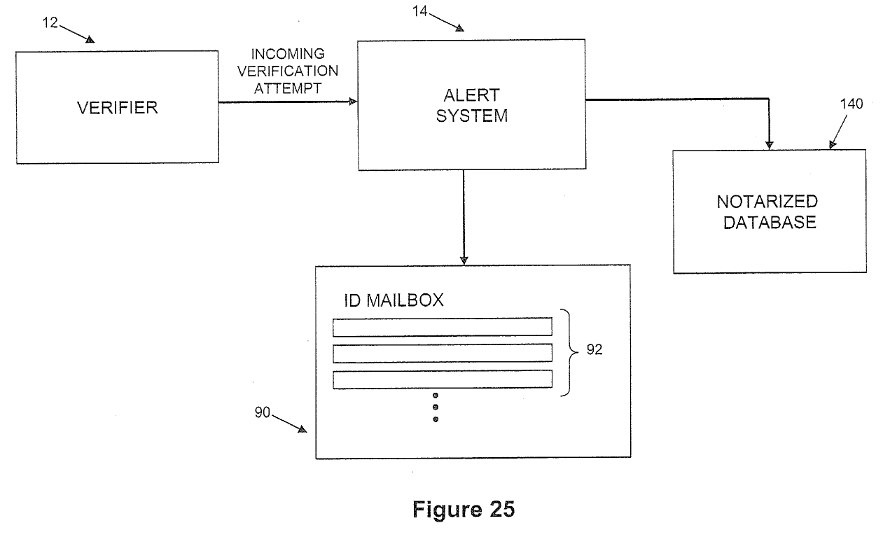

In yet another embodiment, the alert system 14 may track verification attempts made by a verifier 12, using an identification (ID) mailbox 90 as shown in FIG. 25. The ID mailbox 90 sorts and stores records associated with verification attempts into a series of accounts 92. Each account 92 is associated with a particular encrypted version of an identification number, and maintains a list of verification attempts that have been made for that identification number.

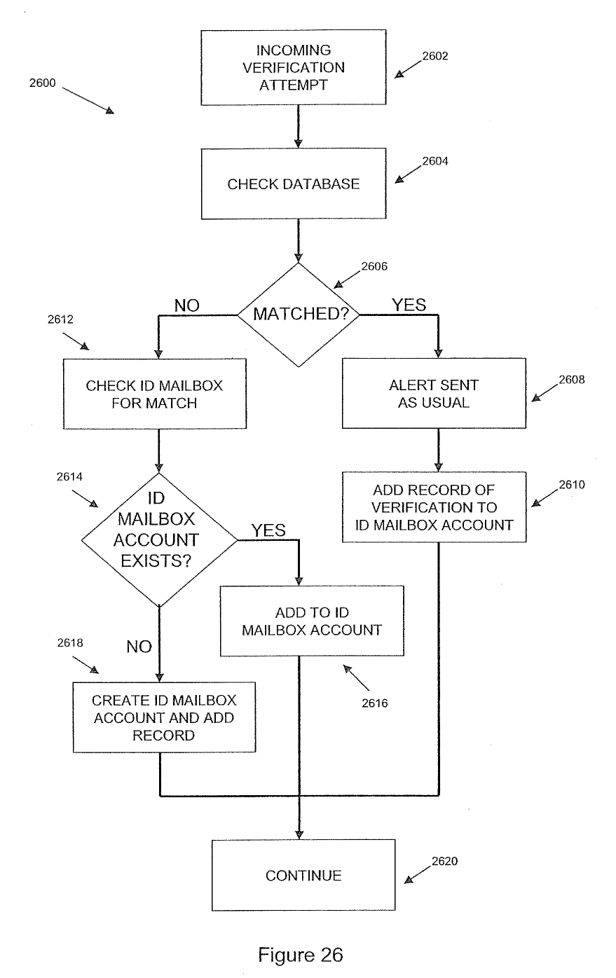

A procedure for handling verification attempts using the ID mailbox 90 is shown in FIG. 26 and generally denoted by numeral 2600. For each a verification attempt made by a verifier 12, the alert system 14 preferably receives this attempt in a message requesting verification of an encrypted version of the identification number as described above (step 2602). In this embodiment, the encrypted version of the identification number is preferably checked against the contents of the notarized database 140 at step 2604. The alert system 14 then determines whether or not the identification number belongs to a registered subscriber 16 at step 2606. If the received encrypted version of the identification number matches an entry in the notarized database 140, an alert is generated and sent as usual at step 2608. A record is then created of the verification attempt, and this record is added to the ID mailbox account 92 that is associated with that particular subscriber 16 at step 2610. Preferably, an ID mailbox account 92 is created upon registration of the subscriber, and thereafter, verification attempt records are automatically added to the account 92.

If the received encrypted version of the identification number does not match an entry in the notarized database 140, the ID mailbox is accessed and the alert system 14 checks for an existing account 92 that is associated with the encrypted version of the identification number at step 2612. At step 2614, the alert system determines if an account 92 exists, and if so, a record of the verification attempt is added to that particular account 92. If an account does not exist, a new ID mailbox account 92 is created and a record of this first verification attempt is added to the mailbox at step 2618 and the alert system 14 then continues its operations at step 2620.

The ID mailbox 90 provides an auditable record of verification attempts made by a verifier 12. This may be valuable to the verifier 12 at a later time should they be unwittingly implicated in a fraud, because a particular identification was used, through them, by an unauthorized user. If the verifier 12 becomes involved in an investigation of the fraud, they would possess a record showing that they attempted to alert the authorized holder of the identification immediately, to prove that they were not an active participant in the fraudulent activity. Since the ID mailbox 90 stores only encrypted versions of the identification numbers, the anonymity of the subscriber would also not be compromised.

The ID mailbox 90 is also useful to subscribers 12 when registering with the alert system 14. Once the subscriber 16 is verified, e.g., by a notary 80, they can access their ID mailbox account 92 and reveal use of their identification prior to subscribing. This can be checked against old statements or records to identify if there has been past fraudulent use of that identification.

The records stored in the accounts 92 also help to prevent a registered subscriber 16 from participating in their own fraudulent scheme, such as that of claiming someone else has used their credit card but it was in fact them. The records could show that the subscriber 16 was alerted to the use of the credit card and accepted that use.

In yet another embodiment, in addition to the contact information, a subscriber 16 may elect to have an important date stored in the database 140 (or 40). This date may then be used by the alert system 14 to return a specific response to a query by a verifier 12. For example, a birth date may be stored by the alert system 14 and associated with a particular subscriber's identity. This birth date could then be returned to a verifier 12, either upon request or automatically, in order to check the age of majority etc. as required. As another example, the date of death may be stored in this manner to provide the verifier 12 with this date, in an attempt to uncover fraudulent transactions that have occurred on or after the date of death, which may be suspect.

In yet another embodiment, the system 10 may be used by subscribers 12 that act on another's behalf (as described above), to monitor only the identities of the deceased and/or minors. Such a system may be implemented to provide accessibility to identity monitoring for those who otherwise could not benefit from such services. This may enable any third party, having the proper authority, to monitor their dependents' identification numbers.

An example may be a system 10 for monitoring the identities of the deceased. In such an embodiment, the subscribers 12 would preferably be one of a relative, power of attorney, or executor of the deceased's estate, although any third party having the proper authority to act on their behalf may also be used. In this example, an executor of the deceased's will can register with the alert system 14 in order to monitor the use of identification belonging to the deceased. Since the identity of a deceased person should not be used subsequent to the death of the individual, the executor may be able to track any fraudulent use of their client's identification. Such a service would provide protection to the family of the deceased individual as well as help to hinder the use of “expired” identification. It will be appreciated that this embodiment may be implemented using any of the above described features as desired. For example, for tracking the identity of a deceased individual, the system 10 may be implemented without storing encrypted versions of the deceased's identification.

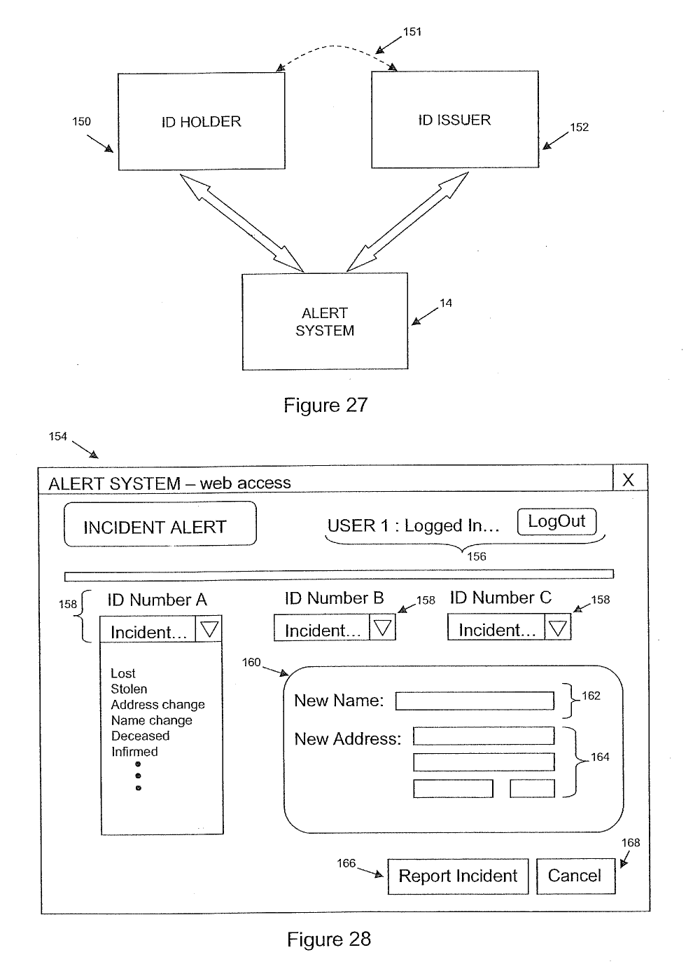

In yet another embodiment, the system 10 may be adapted to enable a secure communication between correspondents that are ID holders 150 and correspondents that are responsible for the personal information of the ID holder 150, such as ID issuers 152, as shown in FIG. 27. Typically, the ID holders are subscribers 16 and the ID issuers may be either a subscriber 16 or a verifier 14 or both. The dashed line 151 shown in FIG. 27 represents a previous communication/interaction between the ID holder 150 and the ID issuer 152, where the ID holder 150 obtains an identification number/card from the ID issuer 152, which may or may not relate to the alert system 14.

In certain situations, ID holders 150 may wish to communicate what they believe are significant incidents to one or more ID issuers 152 associated with their corresponding IDs. Such incidents comprise reporting a card associated with the ID lost or stolen, submitting a request to change information such as name or address, deaths or infirmity etc. Rather than pay for an additional third party service to store aggregated and sensitive personal information so that the service can relay the reported incidents to the respective issuers, the ID holder 150 may instead utilize the existing infrastructure provided by the alert system 14.

Personal information such as credit card numbers, bank account and card numbers, SIN/SSN numbers, passports, driver's licenses, birth certificates etc. is typically sensitive. Various third party services may encrypt and store information but then need to decrypt the information each time a request is made by a client, in order to match the client to the ID in question. The numerous decryptions of the stored data back into a sensitive form may pose a risk of security breach. If the encryption key is compromised through a security breach or internal fraudulent activity occurs, the information is prone to being copied and/or sold. Other inefficiencies due to a reliance on human interaction via phone centres etc. and the overhead of setting up such call centers make these third party services even less desirable.

To avoid these pitfalls, the secure way in which the alert system 14 stores the sensitive information, namely in an encrypted form only with associated contact information, is preferred in order to communicate incidents between ID holders 150 and ID issuers 152.

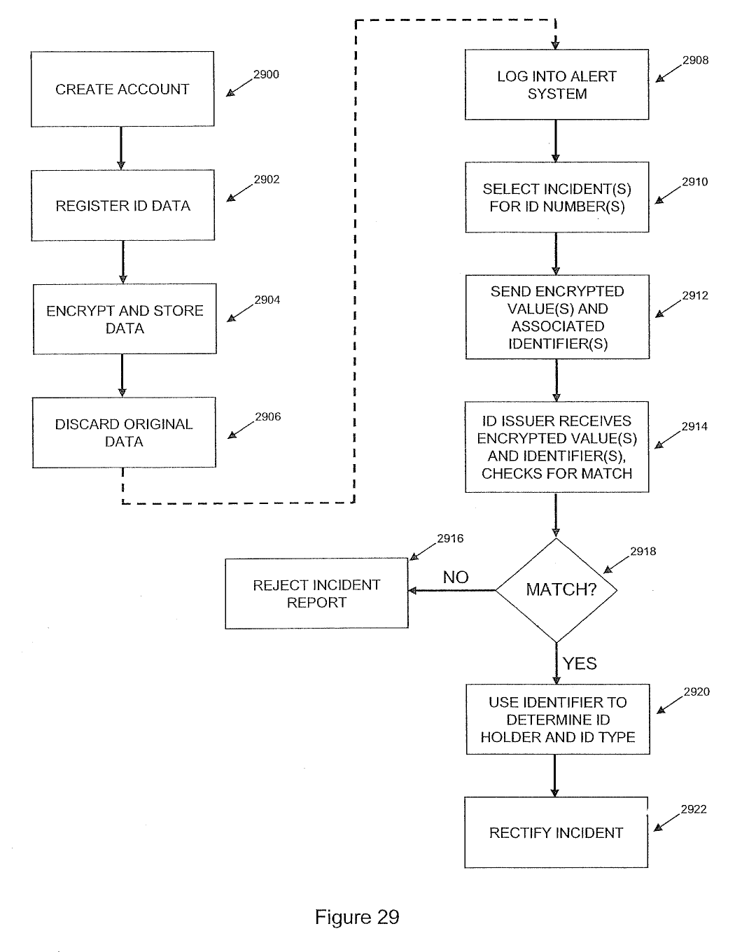

Referring to FIGS. 28 and 29, a process for utilizing the alert system 14 to enable a secure communication between an ID holder 150 and an ID issuer 152 is exemplified. Preferably, steps 2900 to 2906 preceding the dashed line are performed independent of the remaining steps and need not be performed each time an incident is reported. In step 2900, the ID holder 150 and preferably the ID issuer 152 create an account with the alert system 14 according to the principles discussed above. At step 2902, the identification information issued by the ID issuer 152 is registered by the ID holder. The information is encrypted and stored according to the methods described above at step 2904 (see also FIGS. 3 and 4), and the original sensitive identification information discarded at step 2906.

At step 2908, the ID holder 150 logs into the alert system website (see FIG. 5), and accesses an application program interface (API) 154 such as that shown in FIG. 28 that is specific to reporting incidents to the ID issuer 152. The API 154 comprises user-specific information 156 and an ID identifier and incident drop-down list 158 for each ID number. FIG. 28 shows three ID numbers for User 1, namely ID number A, ID number B and ID number C, although it will be appreciated that any number may be shown based on the nature of the ID holder's account.

At step 2910, the ID holder 150 selects an incident from the drop down list 158 for each ID number on which they wish to report. For name and address changes, preferably, entry boxes 160 are provided, including a name entry box 162 and address entry boxes 164. To report the incident(s), the ID holder 150 selects a “Report Incident” button 166 or selects a “Cancel” button 168 to exit the process.

If the ID holder 150 selects the Report button 166, the encrypted version of the ID number is sent at step 2912 to the ID issuer, along with identifying data such as a pointer that correlates the encrypted data to the ID holder 150. The ID issuer 152 preferably uses the same encryption technique as the alert system 14 (see FIG. 3) to encrypt and store ID numbers for its current clients (e.g. ID holder 150) with a pointer (e.g. client reference number) the correlates the client to the number. At step 2914, the ID issuer 152 receives the report and checks its internal database at step 2916 to determine if the encrypted data matches an entry in the database. If not, the ID issuer 152 can reject the incident report at step 2916 and communicate a message to the ID holder 150 via the alert system 14 according to the principles discussed above (e.g. see FIG. 12).

If the ID issuer 152 finds a match, they can use the pointer/identifying information associated with the encrypted version of the ID number at step 2920 to identify the ID holder 150 and can take the necessary steps to rectify the incident at step 2922. For example, if the incident is an address change, the ID issuer 152 can change the information and send a message via the alert system 14 to the ID holder 150 confirming the change. If other ID issuer's have been contacted via the report prepare in the API 154, the ID holder 150 preferably receives a confirmation from each issuer 152. It is seen therefore that the alert system 14 can be used in reverse to enable ID holders 150 to communicate back to the ID issuers 152 as needed. The secure way in which sensitive information is stored minimizes the risk of the actual sensitive information being fraudulently obtained.

In yet another embodiment, the system 10 can be used to store biometric data associated with the subscriber 16. Biometric data is typically stored in a digital format which enables, e.g., a fingerprint or iris scan to be recreated and compared to a living input. Since the biometric data when stored is represented as a series or array of values, the data can be encrypted such that reconstruction of the encrypted data would result in an incorrect image etc. Biometric data can be associated with many types of identification numbers such as passports, SIN/SSN, driver's licenses etc. and thus the secure communication system 10 can be used to store this information in a secure manner to inhibit theft and reproduction of the data.

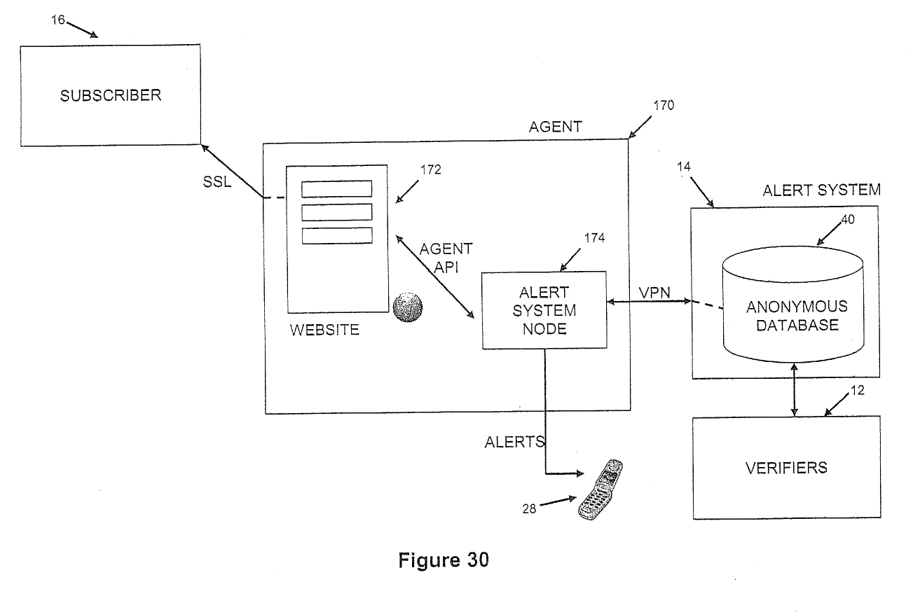

In yet another embodiment, one or more alert system agents 170 can be used to register subscribers 16 to the alert system 14 as shown in FIG. 30. In this way, the alert system 14 can be configured to include only the anonymous database 40 and any software or hardware required to communicate the contents thereof to the agents 170 and verifiers as shown in FIG. 30. The agents 170 in this example manage individual subscribers 16 using an agent website 172. The agents 170 may be existing third party entities such as a bank etc. that already have a website with familiar forms and styles that the subscribers 16 can use to input their identification information and contact information. The website 172 communicates with an alert system node 174, e.g. via an agent API to retrieve and/or alter subscriber information. The node 174 handles the details pertaining to notifications and can log the results for retrieval through the API.

The alert system nodes 174 enables the alert system 14 to scale into any geographical location such that region specific or entity specific configurations can be made at each agent 170 while the central alert system 14 only needs to be responsible for securely storing the information in the anonymous database 40. The alert system nodes 174 do not need to store any sensitive information such as personal account or identification numbers, only contact information that is generally considered non-sensitive or less sensitive. The nodes 174 also do not need to store the hashed versions of the data and only need to relay the hashed versions to the alert system 14 for long term storage. This removes any liability at the node 174 for privacy issues that can result from misplaced or stolen data. The nodes 174 use a secure connection to the database 40, e.g. using a VPN and receives notification events. Moreover, the arrangement shown in FIG. 30 separates contact information from identification data to further protect any sensitive information that is stored by the system 14, in addition to being stored anonymously.

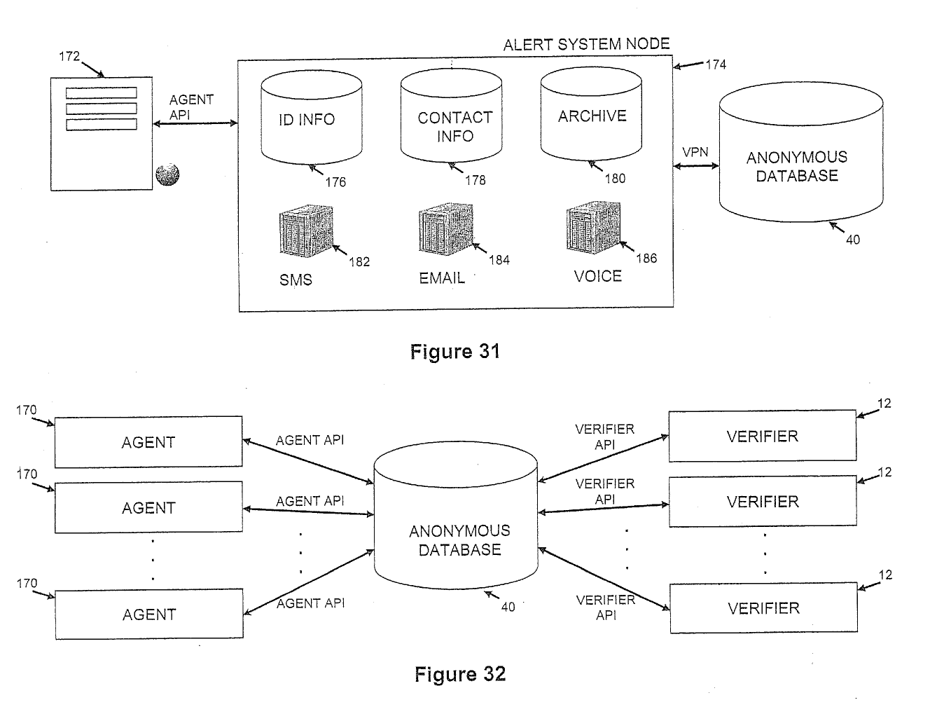

As can be seen in FIG. 31, the alert system node 174 has an identification information data storage 176, a contact information data storage 178, and a notification archive 180 if the agent is equipped for saving notification events. The node 174 includes servers for communicating notifications to the subscriber 16 using various media. In this example, the node 174 includes an SMS server 182, an email server 184 and a voice server 184 to enable the agent 170 to send text, email and voice messages containing such notifications to the appropriate subscriber 16. The data storage 176 is used to store a reference number, specific to each registered ID number stored in the anonymous database 40. The reference number is generated for every ID that is added from the agent site 170 by a subscriber 16. The reference number associates the ID holder (e.g. subscriber 16) with the hashed or anonymous version of the ID data in the anonymous database 40. A query sent from an alert system node 174 may then send the associated reference number to the anonymous database 40. Similarly, any message or query from the anonymous database 40 to the alert system node 174 sends the reference number to enable the agent 170 to properly identify the holder of the ID.

The alert system 14 can therefore be configured to store only the secure data and communicate results of comparisons with the secure data such that a many-to-one relationship can be created as shown in FIG. 32, which is scalable across many entities and across many geographical regions. Multiple agents 170 can be used to register subscribers 16 and multiple verifiers 12 can query identification information through the anonymous database 40.

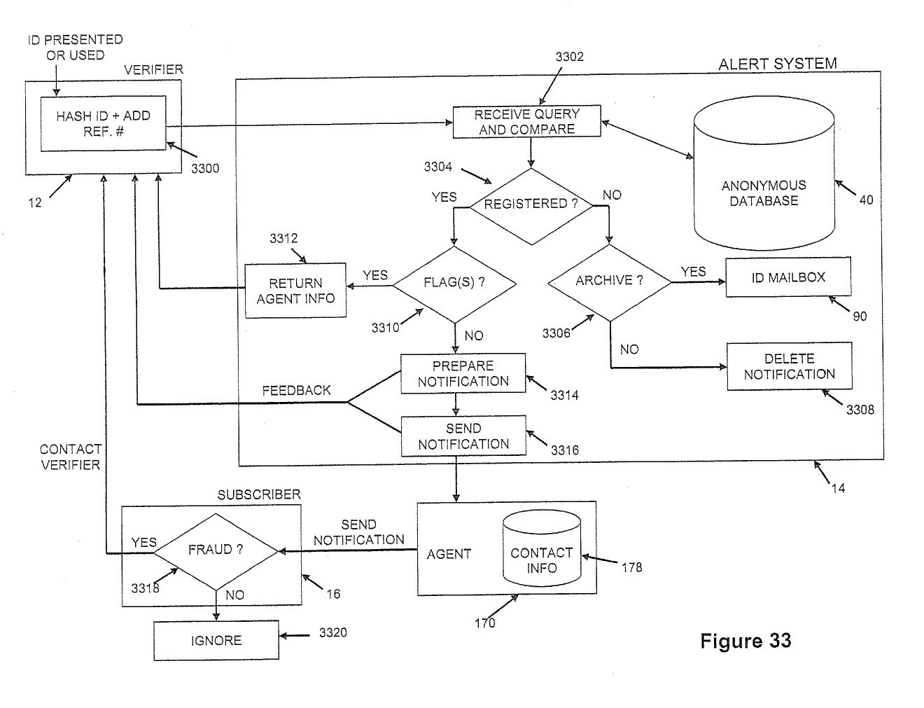

A flow chart showing a notification process using an alert system agent 170 is shown in FIG. 33. In the example shown, identification information is presented to or used at or by the verifier 12 and a hash of the necessary information is generated at step 3300 according to the principles discussed above. The associated reference number for the verifier 12 may be included with the hashed data and sent to the alert system 14, which in this example comprises the anonymous database 40, an ID mailbox 90 and the necessary software or hardware or both to process the verifier's query and send a notification response. At step 3302, the query is received by the alert system 14 and compared to the data stored in the database 40. At step 3304, the alert system 14 determines if the hashed identification number can be found in the database 40 and, if not, determines if the non-registered data should be archived at 3306 (i.e. Does the verifier 12 wish to store the un-registered request for later solicitation?) If the non-registered queries are to be archived, a copy of the information is stored in the ID mailbox 90 for later use as discussed above. If the query is not to be archived, it is deleted at step 3308.

If the identification information matches an entry in the database 40, at step 3310 the alert system 14 then determines if any flags have been placed on the ID by the ID holder. The flags may include deceased, infirmed, lost, stolen, frozen etc. and enable ID flagging to be used whether or not the ID issuer is even registered with the system 10. For example, it may be determined that the associated person constituting the match is deceased and, if so, the necessary information indicating that a deceased individual's information is being used, is returned to the verifier 12 at step 3312 so that they may take the appropriate action. If the match does not have any flags associated with it, i.e. if no restrictions have been placed on the ID by the ID holder (e.g. if the match does not correspond to a deceased individual), a notification response is prepared at step 3314 and sent to the agent 170 at step 3316. Feedback on the notification process may also be sent to the verifier 12 as shown in FIG. 33.

The agent 170, now possessing the results of a successful match may then prepare an appropriate notification using the user-defined preferred delivery method (e.g. SMS, email, voice etc.) and the notification is sent to the subscriber 16. The subscriber 16 may then review the notification at step 3318 and if the notification indicates fraudulent activity, the subscriber 16 can contact the verifier 12 to take appropriate action. For example, in for active responses, the verifier 12 may cancel or reject a transaction in response to a cancellation notice sent by the subscriber 16. If the notification does not provide any indication of fraudulent activity, the subscriber may simply ignore/accept the notification at step 3320 wherein, e.g. the transaction can be approved etc.

The above illustrates that the system 10 may be implemented in any number of ways depending on the application. The system 10 enables the monitoring of identification as well as secure communication between correspondents, and is preferably implemented using a secure mechanism for storing sensitive information and securely associating this sensitive information with contact information for the particular correspondent.

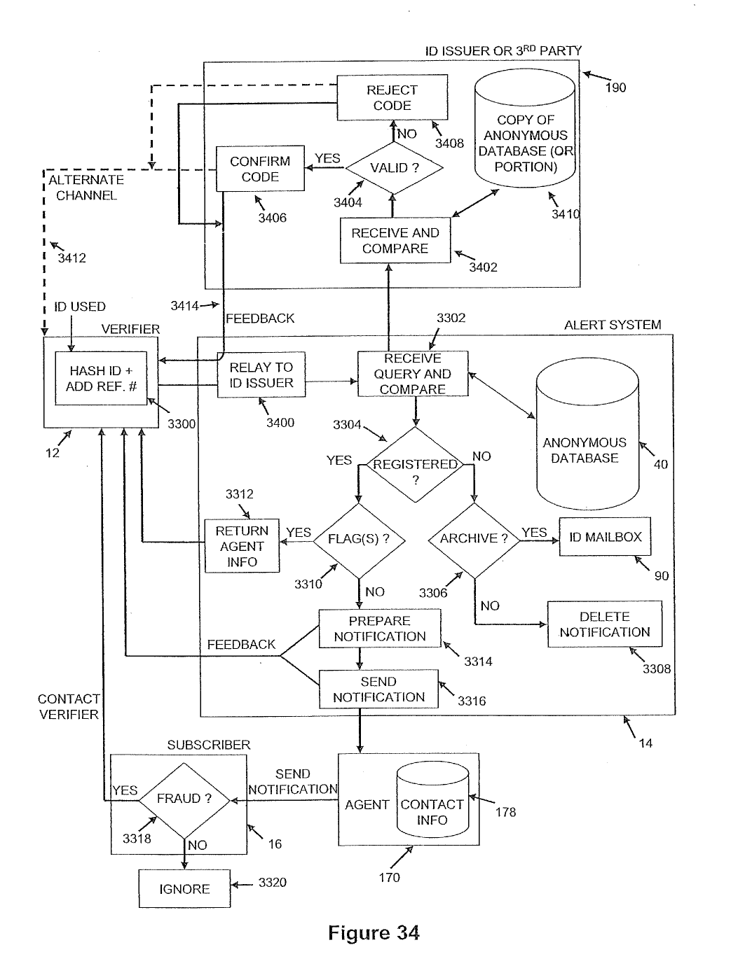

Referring now to FIG. 34, in yet another embodiment, the configuration shown in FIG. 33 can be extended to permit communications between the ID issuer 190 and the verifier 12, preferably through the alert system 14, but also directly, if possible. In this embodiment, an initial hash of the ID that is generated at step 3300 would be intercepted by a relay stage 3400 before entering the normal comparison steps 3302-3316 described above. The relay 3400 would, in addition to passing the hashed ID through to step 3302, pass the hash of the ID to the ID issuer (or other 3^{rd} party if desired) and, at step 3402, the hash would be compared to a copy of the anonymous database 3410 (or a portion thereof). This comparison enables the ID issuer 190 to also determine if there is a match with the ID being used at step 3300. This enables identification that has not entered the system 14 yet to be associated with the issuer for coordinating the use of the ID mailbox 90 etc. The incoming hash of the ID would then be examined at step 3400 to isolate the ID issuer from an issuer field code that is provided by the verifier 12 in the message. This enables the relay 3400 to direct the hash to the appropriate ID issuer 190. It may therefore be appreciated that the relay 3400 may be connectable to any number of ID issuers 190.

At step 3404, the ID issuer 190 then determines if a match is found, as well as determine if any of its own flags have been set, e.g. not issued, deceased, infirm, lost, stolen etc. If there is no match and/or one or more of the flags have been set, a reject code can be generated at step 3408. The reject code can specify the nature of the rejection or simply indicate that there is an issue with the verification. The reject code 3408 may then be sent as feedback to the verifier 12 through a feedback channel 3414 that is relayed in the opposite direction through the relay 3400. It can be seen in FIG. 34 that if possible or desired, an alternative direct channel from the ID issuer 190 to the verifier 12 can be used to directly notify the verifier 12 of the issues. If there is a match and the ID is valid, a confirm code may be generated at step 3406, which can be sent back to the alert system 14 and the verifier 12 through the relay 3400. It will be appreciated that a third party database or entity can be used on behalf of the ID issuer 190, however, it is preferable to have the ID issuer 190 maintain control of any copy of the anonymous database 40.

The embodiment in FIG. 34 enables verifiers 12 to determine not only if the ID number that has been presented to them is valid, but also if the number has actually be issued to a proper individual through the ID issuer 190. For example, verifiers 12 may be presented with seemingly valid ID, which may be random numbers with a thief's photo and false name on a counterfeit card. As such, although the thief may be able to set up an alert account through the alert system 14 for that counterfeit card, the actual ID issuer would be able to confirm that it was the entity that created the number and the card.

For credit cards, part of the existing authorization system typically establishes if the credit card number is valid, but such a system is not typically available for government issued ID. Even if a government entity did establish their own system, a verifier would have to access a separate site for each issuer, which can be inefficient. Moreover, even if the ID is valid, verifiers 12 would still need to confirm that they are dealing with the authorized holder of the ID.

The configuration shown in FIG. 34 however, provides a central platform to enable the verifier 12 to fully and properly verify an ID as necessary, by way of a communication link with any ID issuer 190. This enables the verifier to determine whether the ID issuer 190 actually issued the ID as well as ensure that they are actually dealing with a legitimate ID issuer 190.

Although the invention has been described with reference to certain specific embodiments, various modifications thereof will be apparent to those skilled in the art without departing from the spirit and scope of the invention as outlined in the claims appended hereto. The entire disclosures of all references recited above are incorporated herein by reference.

What is claimed is:

1. A method for updating information associated with identification information, said method comprising:
receiving a secure version of an identification datum and an indication of an incident associated with said identification datum, said incident being related to said identification datum;
comparing said secure version of said identification datum to stored identification data; and
if said stored identification data comprises said identification datum, updating information specific to said datum.

2. The method of claim 1 further comprising notifying a holder of said identification datum of said update.

3. The method of claim 1 wherein said secure version is an encrypted version of said identification datum.

4. The method of claim 3 wherein said encrypted version is computed using a one-way hash function and said hash function comprises a plurality of fields, each of which corresponds to a portion of said identification datum.

5. The method of claim 4 comprising three fields corresponding to an identification issuer, an identification type and an identification number respectively.

6. A method of identity monitoring comprising the steps of:
a notification system storing biometric identification information and contact information for each of at least one subscriber, said identification being stored in a secure manner;
said notification system receiving a query from a verifier indicative of the use of queried biometric identification information;
said notification system using said query to retrieve contact information corresponding to said queried biometric identification information if said queried biometric identification information corresponds to one of said at least one subscriber; and
if retrieved, said notification system using said contact information to notify said one of said at least one subscriber of the use of said queried biometric identification information.

7. The method of claim 6 wherein said notification system stores an encrypted version of said identification information.

8. The method of claim 7 wherein said encrypted version is computed using a one-way hash function and said hash function comprises a plurality of fields, each of which corresponds to a portion of said identification information.

9. The method of claim 8 comprising three fields corresponding to an identification issuer, an identification type and an identification number respectively

10. A notification system for identity monitoring comprising:
a storage device for storing biometric identification information and contact information for each of at least one subscriber, said biometric identification information being stored in a secure manner;
an interface adapted to enable a verifier to submit a query indicative of the use of queried biometric identification information; and
a server connected to said interface and said storage device, said server capable of receiving said query from said interface and transmitting a notification message to each of said at least one subscriber over a communication channel, said server using said query to retrieve contact information corresponding to said queried biometric identification information if said queried biometric identification information corresponds to one of said at least one subscriber; and if retrieved, said server using said contact information to notify said one of said one of said at least one subscriber of the use of said queried biometric identification information.

11. The system of claim 10 wherein said notification system stores an encrypted version of said identification information.

12. The system of claim 11 wherein said encrypted version is computed using a one-way hash function and said hash function comprises a plurality of fields, each of which corresponds to a portion of said identification information.

13. The system of claim 12 comprising three fields corresponding to an identification issuer, an identification type and an identification number respectively.

14. The system of claim 10 wherein said interface is adapted to alter said identification information to match a representation thereof as securely stored by said notification system.

15. A notification system for identity monitoring comprising:
an alert system comprising a database storing encrypted versions of identification data for one or more subscribers; and
at least one verification agent comprising contact information for said one or more subscribers;
wherein said alert system is configured to receive queries from one or more verifiers, said queries comprising encrypted versions of identification data to be verified; compare said received encrypted versions to those stored in said database; and send a result of said comparison to one of said at least one verification agent for notifying a respective one of said subscribers.

16. The notification system of claim 15 comprising a relay for relaying said received encrypted versions to a corresponding ID issuer to enable said ID issuer to determine if the corresponding identification data is permitted to be used.

17. The notification system of claim 15 wherein said agent comprises an alert system node for interfacing between an application provided to said subscriber and said alert system.

18. A method for anonymously storing identification data comprising:
separating said identification data into a plurality of fields comprising a first field containing an identification number and a second field containing information associated with said identification number;
applying a one-way hash function to each said first field and said second field to generate a first hashed field and a second hashed field respectively; and
storing said first hashed field with said second hashed field;
wherein said first and second hashed fields are each compared to corresponding input hashes for verifying said identification data.

19. A memory for storing identification data for access by an identity verification application program being executed on a data processing system comprising one or more data structures stored in said memory, said data structures including a plurality of hashed data fields stored with each other in said memory, said plurality of hashed data fields comprising a first hashed field of a first field of said identification information containing an identification number, and a second hashed field of a second field of said identification information containing information associated with said identification number.
